(19) United States
(12) Patent Application Publication
(10) Pub. No.: US 2014/0198770 A1
(43) Pub. Date: Jul. 17, 2014

(54) NODE DEVICE, COMMUNICATION METHOD, AND STORAGE MEDIUM

(71) Applicant: FUJITSU LIMITED, Kawasaki-shi (JP)

(72) Inventors: Tetsu Yamamoto, Fukuoka (JP); kazuya KAWASHIMA, Fukuoka (JP); Tadashige IWAO, Kawasaki (JP)

(73) Assignee: FUJITSU LIMITED, Kawasaki-shi (JP)

(21) Appl. No.: 14/216,462

(22) Filed: Mar. 17, 2014

Related U.S. Application Data
(63) Continuation of application No. PCT/JP2011/071402, filed on Sep. 20, 2011.

(51) Int. Cl. H04W 36/22

(52) U.S. Cl. CPC H04W 36/22
USPC 370/331

(57) ABSTRACT

Anode device includes a receiver, a processor, memory, and a transmitter. The receiver receives a path information packet for notification of path information about a network. The processor generates a participation request packet for requesting a first node device selected between an adjacent node device and a node device communicable through the adjacent node device to participate in a first local cluster. The memory stores a path to each affiliated node device affiliated with the first cluster. The transmitter transmits the participation request packet to the first node device. When a number of affiliated node devices which are affiliated with the first cluster exceeds a threshold, the processor generates a generation request packet for requesting a second node device which is not affiliated with the first cluster to generate a second cluster different from the first cluster. The transmitter transmits the generation request packet to the second node device.

### CROSS-REFERENCE TO RELATED APPLICATIONS

This application is a continuation of PCT application of International Application PCT/JP2011/071402 filed on Sep. 20, 2011, and designated the U.S., the entire contents of which are incorporated herein by reference.

### FIELD

The embodiments discussed herein are related to a communication method used among a plurality of node devices affiliated with a network, and the node devices.

### BACKGROUND

A node device affiliated with a wireless ad hoc network uses a Hello packet to propagate routing information. For example, a node device A which is affiliated with the ad hoc network illustrated in FIG. 1 generates Hello packet including routing information held by the node device A, and periodically performs a broadcast. Upon receipt of the Hello packet, a node device B compares the routing information held by the node device B with the information included in the Hello packet, and acquires the routing information not held by the node device B from the Hello packet. Furthermore, the node device B acquires the quality information about a path from the Hello packet, and performs a communication using a path having higher quality information. The quality information also includes loop information. Thus, the node device which is affiliated with an ad hoc network learns the path information to another node device included in the network using the Hello packet, and performs a communication using the obtained optimum path. Each node device included in the ad hoc network holds paths to all other network devices in the ad hoc network in a routing table. For example, the node device A holds in the routing table the path information to each node device other than the node device A in the ad hoc network. Therefore, for example, the node device A may transmit a data packet to a node device C through the node device B.

Well known as a related technology is a communication method in which a node device which has received a packet compares the identification information about a stored packet to be transmitted with the identification information about the received packet. In this method, the transmittability of a path to the final destination of a search data packet is judged based on the result of the comparison. Furthermore, there is also a method proposed for weighting a node which relays a packet, and determining the destination of the packet based on the result of weighting. Also well known is a method for forming a cluster by a plurality of node devices arranged in the vicinity, and selecting a cluster head in the cluster so that a node device having a larger number of adjacent nodes may be selected as a cluster head at a higher probability. There is also a method proposed for creating in tree form a plurality of stable paths based on the position information about a radio sensor node and radio intensity, and grouping the nodes.

### DOCUMENTS OF PRIOR ARTS

### Patent Documents

[Patent Document 1] International Publication Pamphlet No. WO2011/013165

[Patent Document 2] International Publication Pamphlet No. WO2009/130918

[Patent Document 3] Japanese Laid-open Patent Publication No. 2008-312059

[Patent Document 4] Japanese Laid-open Patent Publication No. 2007-243794

In the method described in the BACKGROUND above, when the number of node devices included in a network increases, the routing table held by each node becomes larger. If a formed cluster or group becomes large, there is the problem of a large routing table although a plurality of node devices in a network are formed as a cluster or a group.

### SUMMARY

According to an aspect of the embodiments, a node device includes a receiver, a processor, memory, and a transmitter. The receiver receives a path information packet for notification of path information about a network. The processor generates a participation request packet for requesting a first node device selected between an adjacent node device and a node device communicable through the adjacent node device to participate in a first local cluster. The memory stores a path to each affiliated node device affiliated with the first cluster. The transmitter transmits the participation request packet to the first node device. When a number of affiliated node devices which are affiliated with the first cluster exceeds a threshold, the processor generates a generation request packet for requesting a second node device which is not affiliated with the first cluster to generate a second cluster different from the first cluster. The transmitter transmits the generation request packet to the second node device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of an ad hoc network;

FIG. 2 is an example of a generated cluster;

FIGS. 3A and 3B are examples of configurations of a node device;

FIGS. 4A through 4C are explanatory views of examples of configurations of a packet;

FIG. 5 is an example of a hardware configuration of a node device;

FIG. 6 is an example of a link table;

FIG. 7 is a flowchart for explanation of an example of an operation of a path management unit when a link table is updated;

FIG. 8 is an example of an unaffiliation table;

FIG. 9 is a flowchart for explanation of an example of an operation of a unaffiliated node specification unit when an unaffiliation table is updated;

FIGS. 10A through 10D are explanatory views of examples of a cluster generation method;

FIG. 11 is an example of a cluster table;

FIG. 12 is an example of generating a cluster by an originating node device;

FIG. 13 is a sequential view for explanation of an example of the process performed when a cluster is generated;

FIG. 14 is an example of a configuration of a cluster data packet;

FIG. 15 is an explanatory view of an example of specifying a new originating node device and generating a cluster;

FIG. 16 is a sequential view for explanation of an example of a communication performed when a new originating node device is specified and a cluster is generated;

FIG. 17 is a flowchart for explanation of an example of the procedure of generating a cluster;

FIG. 18 is a flowchart for explanation of an example of an operation performed when an unaffiliated node is requested to participate in a cluster;

FIG. 19 is a flowchart for explanation of an example of the operation performed when a new cluster is generated;

FIG. 20 is an explanatory view of an example of generating a Hello packet in a node device affiliated with a cluster;

FIG. 21 is a flowchart for explanation of an example of an operation performed when a node device receives a Hello packet;

FIG. 22 is a flowchart for explanation of an example of an operation performed when a routing table is updated;

FIG. 23 is a flowchart for explanation of an example of an operation performed when a cluster table is updated;

FIG. 24 is a flowchart for explanation of an example of an operation performed when a routing table is updated;

FIG. 25 is a flowchart for explanation of an example of an operation performed when a cluster table is updated;

FIGS. 26A through 26D are explanatory views of examples of a method of determining a sub-gateway;

FIG. 27 is an explanatory view of an example of a method of recognizing the ID of a cluster adjacent to a local cluster;

FIG. 28 is an explanatory view of an example of an operation of an originating node device performed when a notification of an adjacent cluster is received;

FIG. 29 is a sequential view for explanation of an example of an operation performed when a sub-gateway is determined;

FIG. 30 is a flowchart for explanation of the operation of an adjacent cluster notification unit;

FIG. 31 is a flowchart for explanation of an example of an operation of a candidate table generation unit when an adjacent cluster is notified;

FIG. 32 is a flowchart for explanation of an example of an operation of an originating node device when a sub-gateway is generated;

FIG. 33 is a flowchart for explanation of an operation of a node specified by a sub-gateway;

FIG. 34 is an example of a format of a data packet;

FIG. 35 is a flowchart for explanation of an example of an operation performed when a data packet is received;

FIG. 36 is an example of a format of a highway data packet;

FIGS. 37A through 37D are explanatory views of an example of a method of communicating with a node device not included in a local cluster;

FIG. 38 is an example of a format of a search data packet;

FIG. 39 is an explanatory view of a method of retrieving a destination of a data packet and an example of transmitting a data packet;

FIG. 40 is a flowchart for explanation of an example of a process of a search data packet; and

FIG. 41 is a flowchart for explanation of an example of a process of a highway data packet.

### DESCRIPTION OF EMBODIMENTS

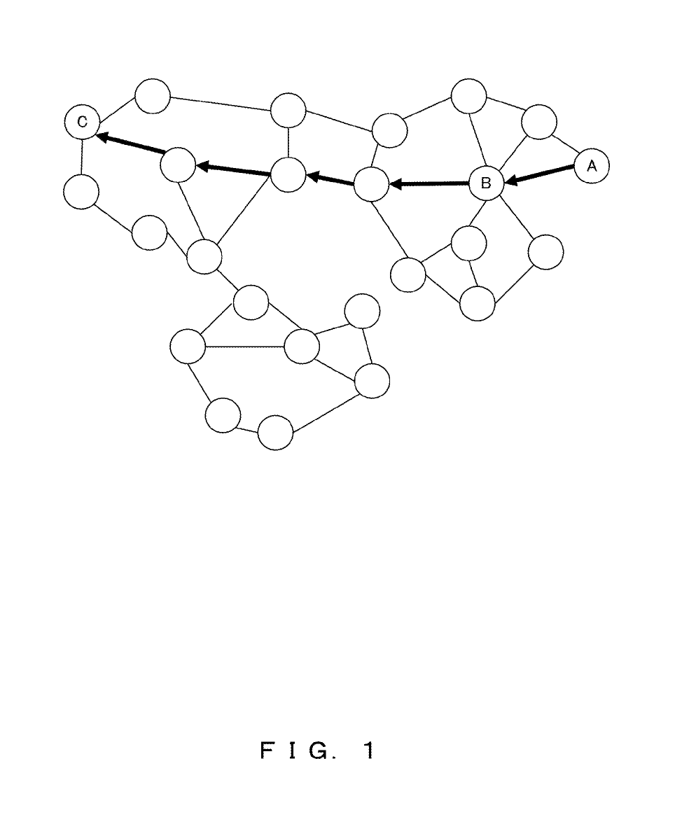

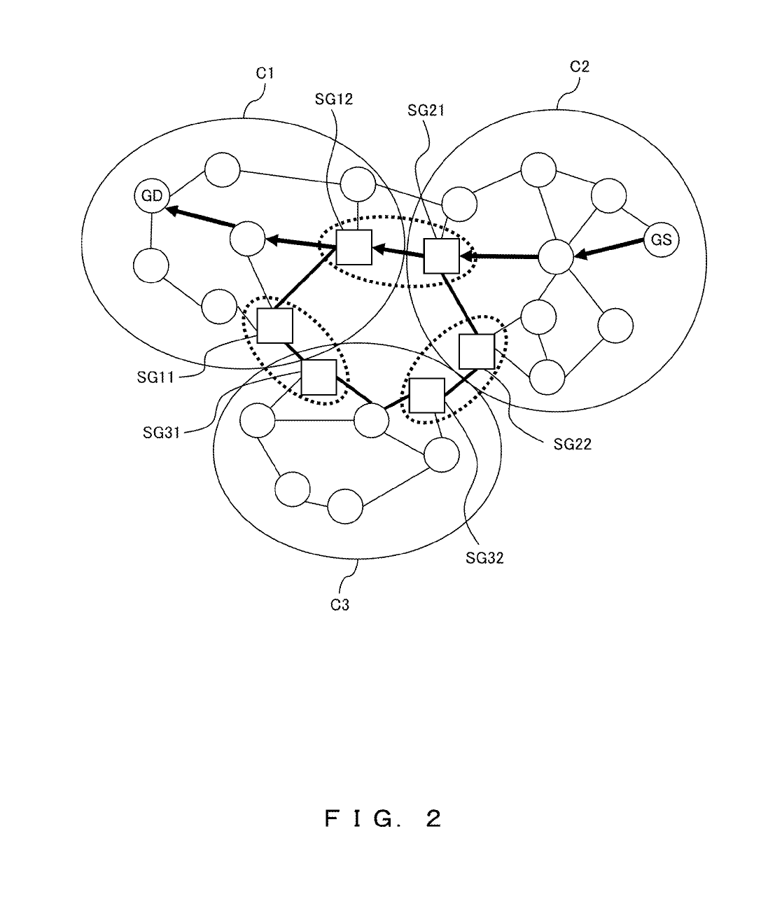

FIG. 2 is an example of a generated cluster. In the example in FIG. 2, the ad hoc network illustrated in FIG. 1 is divided into three clusters C1 through C3. Each of the node devices included in the ad hoc network recognizes an adjacent node device by communicating a path information packet for notification of the path information about a network. In the following explanation, it is assumed that the path information packet is a Hello packet. It is also assumed that an “adjacent node device” of a node device located in a range in which a packet transmitted from a certain node device may be received.

An originating node device transmits a control packet used in requesting an adjacent node device to be affiliated with the same cluster as the originating node device. In this case, the originating node device stores a threshold indicating the number of node devices which may be included in one cluster, and includes node devices of the number not more than the threshold in one cluster. When a node device is affiliated with a cluster, the node device transmits a Hello packet including an identifier for identification of the cluster with which the node device has been affiliated. The node device records in the routing table the path to the node device affiliated with the same cluster. However, the node device does not record in the routing table the information about the node device which is affiliated with a different cluster.

In each cluster, a “sub-gateway” (SGW) is selected from among nodes communicable with a node device in an adjacent cluster. In the example in FIG. 2, the nodes (SG 11 through 32) expressed by the respective squares are sub-gateways. The node device which operates as a sub-gateway includes in the routing table the information about the sub-gateway included in the cluster adjacent to the cluster with which the node device is affiliated. For example, the sub-gateway SG21 holds the information about the SG12. Therefore, the node device may transmit through a sub-gateway a packet to another node device in the cluster different from the cluster with which the node device is affiliated. For example, the node device affiliated with the cluster C2 may transmit a packet to a node device affiliated with the cluster C1 through the sub-gateways SG21 and the SG12.

Thus, if the number of node devices affiliated with each cluster is limited, and the path to a node device in each cluster is recorded in the routing table held by the node device other than the sub-gateway, then the expansion of the routing table in the node device may be suppressed. Furthermore, a sub-gateway also includes the information about the node in an adjacent cluster in addition to the path to a node device in the cluster with which the sub-gateway is affiliated. Therefore, the node device may transmit a packet to the node affiliated with another cluster through the sub-gateway. Furthermore, the path information held by a sub-gateway includes the path to the node in the cluster with which the sub-gateway is affiliated and the path to the node device affiliated with the adjacent cluster. Therefore, even for a node device selected by the sub-gateway, the number of paths included in the routing table is smaller than the number of paths to each of the node devices included in the entire network. Therefore, by the method according to an embodiment of the present invention, the size of the routing table held by the node device in the network may be reduced.

<Device Configuration>

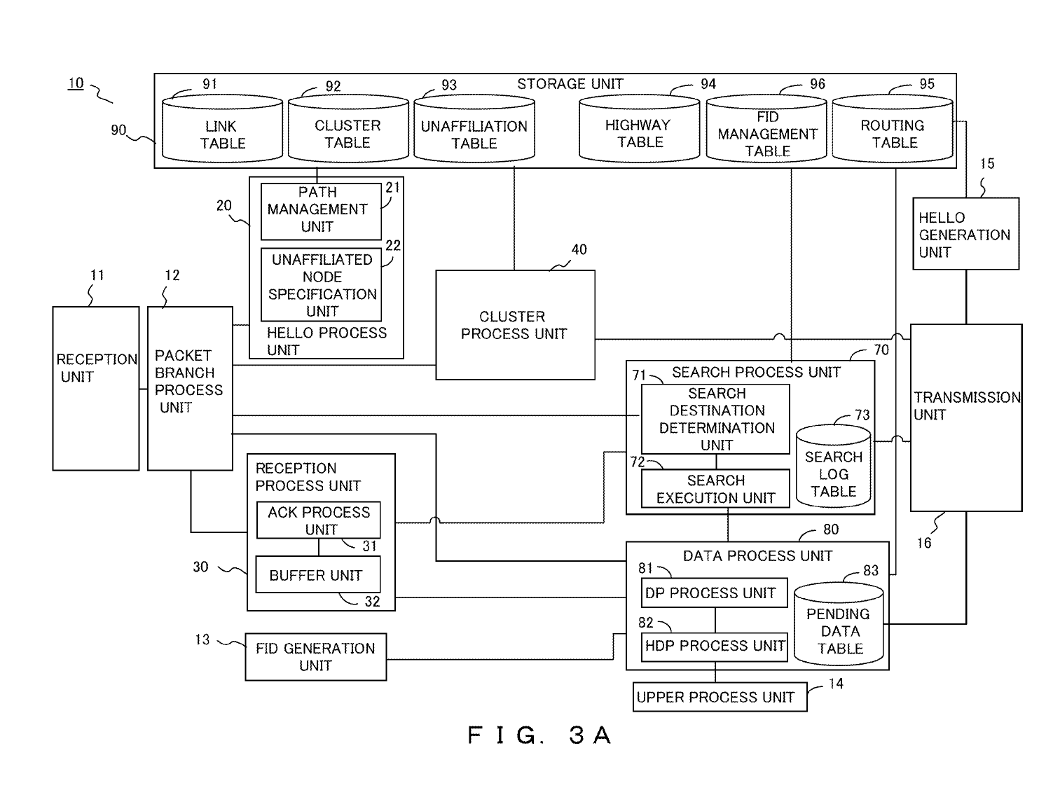

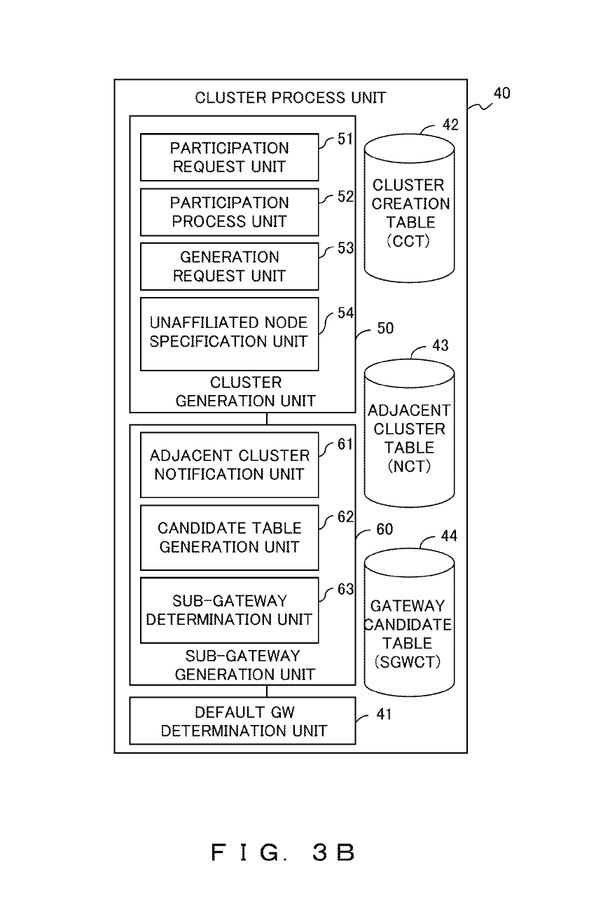

FIGS. 3A and 3B are examples of configurations of a node device 10. The node device 10 includes a reception unit 11, a packet branch process unit 12, an FID (frame identification) generation unit 13, an upper process unit 14, a Hello generation unit 15, a transmission unit 16, a Hello process unit 20, a reception process unit 30, a cluster process unit 40, a search process unit 70, a data process unit 80, and a storage unit 90. The reception unit 11 receives a packet from an adjacent node device 10.

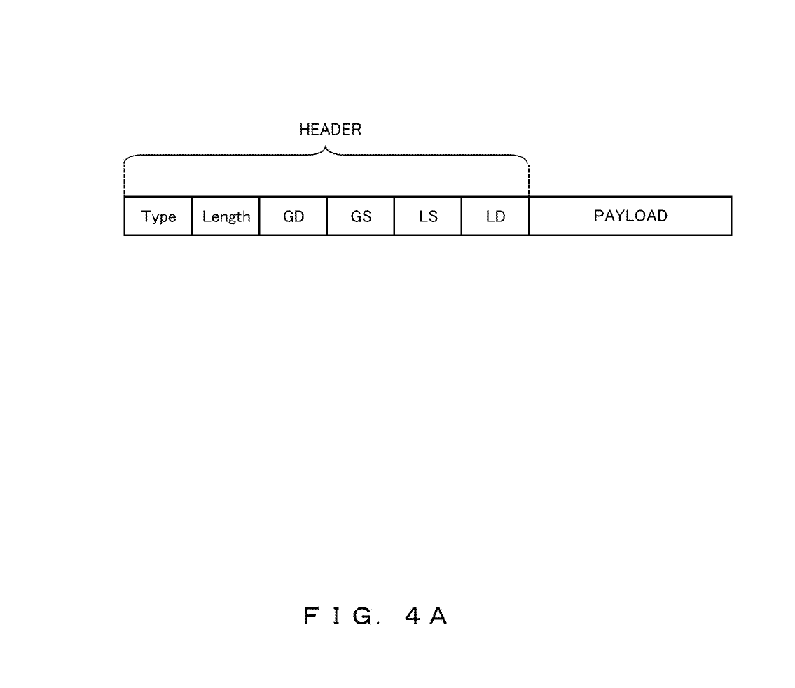

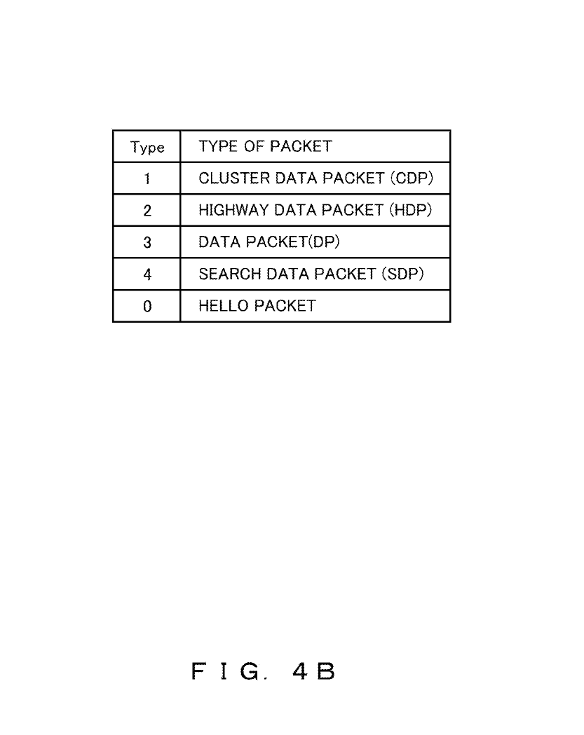

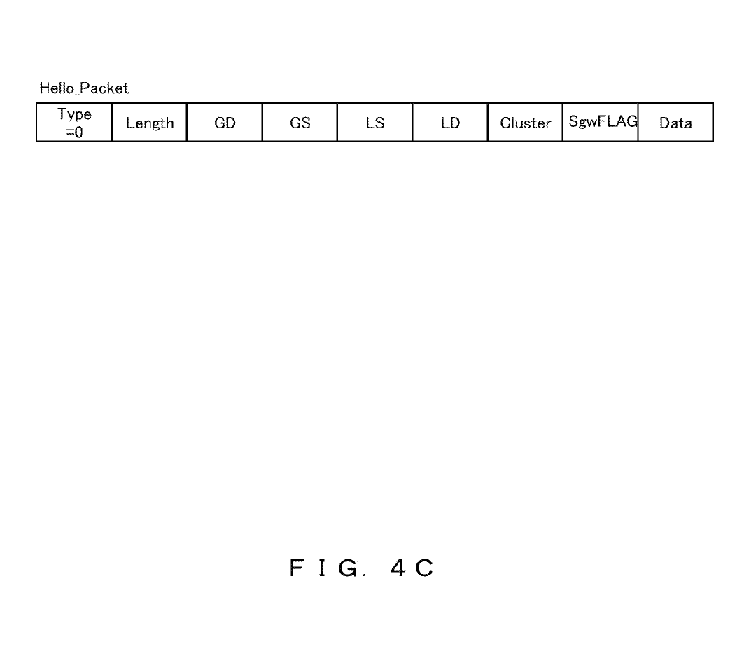

FIG. 4A is an example of a configuration of a packet communicated between the node devices 10. A packet includes a header and a payload. The header is in common form regardless of the type of packet, and includes a Type field, a Length field, a global destination (GD) field, a global source (GS) field, a local source (LS) field, and a local destination (LD) field.

In the following explanation, it is assumed that a “global destination” indicates the final destination node device 10 of a packet. On the other hand, a “local destination” indicates a node device 10 specified as a destination when 1-hop forwarding is processed to transmit a packet to a global destination. A “local source” indicates the node device 10 from which a packet is 1-hop forwarded. A “global source address” indicates the node device 10 which has generated the packet. A device may be indicated by a device-specific identifier (ID) such as a (MAC) address etc.

The Type field indicates the type of data included in the payload. An example of the relationship between the value of the Type field and the type of packet is illustrated in the table in FIG. 4B. In the Hello packet, the value of the Type field is set to “0”. The packet having the value of “1” of the Type field is a cluster data packet (CDP). The packet having the value of “2” of the Type field is a highway data packet (HDP). The packet having the value of “3” of the Type field is a data packet (DP). The packet having the value of “4” of the Type field is a search data packet (SDP). Each packet is described later in detail. In these packets, the cluster data packet, the search data packet, and the Hello packet are used in controlling the node device 10. In the following descriptions, the cluster data packet, the search data packet, or the Hello packet may be referred to as a “control packet”. The Length field indicates the length of a packet.

The packet branch process unit 12 judges the type of received packet by the value of the Type field in the received packet, and outputs each type of packet to a specified destination. The packet branch process unit 12 outputs a Hello packet to the Hello process unit 20. A cluster data packet is output to the cluster process unit 40, and a highway data packet is output to the data process unit 80. A data packet is output to the reception process unit 30 when it is an acknowledgment (ACK) packet. However, a data packet other than an ACK packet is output to the data process unit 80. The packet branch process unit 12 outputs a search data packet to the search process unit 70. The information included in a packet is described later.

The Hello process unit 20 includes a path management unit 21 and an unaffiliated node specification unit 22. The Hello process unit 20 acquires the information included in the Hello packet, and updates a link table 91, a cluster table 92, an unaffiliation table 93, and a routing table 95. The link table 91, the cluster table 92, the unaffiliation table 93, and the routing table 95 are stored in the storage unit 90. The link table 91 stores the identifier of a cluster with which the adjacent node device 10 is affiliated and the information about whether or not the adjacent node device 10 is specified for the sub-gateway, etc. as associated with the identifier of the adjacent node device 10. The cluster table 92 records the information about the node devices affiliated with the same cluster as the node device 10. The unaffiliation table 93 records the information about the node device 10 not affiliated with a cluster. In the explanation below, the node device 10 which is not affiliated with a cluster may be described as a “unaffiliated node device”. The routing table 95 records the path to a node device 10 affiliated with the same cluster as the node device 10. The link table 91, the cluster table 92, the unaffiliation table 93, and the routing table 95 are described later in detail.

The cluster process unit 40 includes a cluster generation unit 50, a sub-gateway generation unit 60, a default GW determination unit 41, a cluster search table (CCT) 42, an adjacent cluster table (NCT) 43, and a gateway candidate table (SGWCT) 44. The cluster generation unit 50 includes a participation request unit 51, a participation process unit 52, a generation request unit 53, and an unaffiliated node specification unit 54. In the node device 10 selected as an originating node device, the participation request unit 51, the generation request unit 53, and the unaffiliated node specification unit 54 operate. On the other hand, in the node device 10 not selected as an originating node device, the participation process unit 52 operates. The operations of the participation request unit 51, the participation process unit 52, the generation request unit 53, and the unaffiliated node specification unit 54 are described later. The cluster creation table 42 is used when the participation request unit 51 operates in the node device 10 newly specified as an originating node device by the generation request unit 53, and records the information etc. about the node device 10 specified as an originating node device. The unaffiliated node specification unit 54 uses the information stored on the unaffiliation table 93, and appropriately updates the table.

The sub-gateway generation unit 60 includes an adjacent cluster notification unit 61, a candidate table generation unit 62, and a sub-gateway determination unit 63. The candidate table generation unit 62 and the sub-gateway determination unit 63 operate in the node device 10 which is operating as an originating node device. On the other hand, it is assumed that the adjacent cluster notification unit 61 may operate in the node device 10 which is not operating as an originating node device and in an originating node device. The adjacent cluster table 43 and the gateway candidate table are referred to by the operation of the sub-gateway determination unit 63 and the candidate table generation unit 62. The default GW determination unit 41 operates in the node device 10 which is not set by a sub-gateway. The default GW determination unit 41 determines a sub-gateway (default gateway) to be used in transmitting a packet to the node device 10 affiliated with another cluster. The adjacent cluster notification unit 61, the candidate table generation unit 62, the sub-gateway determination unit 63, the adjacent cluster table 43, and the gateway candidate table 44 are also described later.

The search process unit 70 includes a search destination determination unit 71, a search execution unit 72, and a search log table 73. The search destination determination unit 71 and the search execution unit 72 operate by a sub-gateway. The search destination determination unit 71 and the search execution unit 72 use the search log table 73 and a highway table 94 to search for the destination of a highway data packet. The communication using a highway data packet is described later.

The data process unit 80 includes a data packet (DP) process unit 81, a highway data packet (HDP) process unit 82, and a pending data table 83. The highway data packet process unit 82 may convert a highway data packet received from the packet branch process unit 12 into a data packet. The highway data packet process unit 82 outputs a data packet obtained by the conversion to the data packet process unit 81. Furthermore, the highway data packet process unit 82 may convert the data packet from the data packet process unit 81 into a highway data packet and output the packet to the transmission unit 16. The data packet process unit 81 processes the data packet input from the packet branch process unit 12, the data packet input from the highway data packet process unit 82, and the data packet from the upper process unit 14. The data packet process unit 81 may appropriately output the information included in the data packet to the upper process unit 14. In the upper process unit 14, a process is performed by the appropriate of an upper layer. In addition, the data packet process unit 81 and the highway data packet process unit 82 generate a packet using a FID input from the FID generation unit 13. The process on a highway data packet is also described later.

The reception process unit 30 includes an ACK process unit 31 and a buffer unit 32. The ACK process unit 31 confirms the contents of the data packet received from the packet branch process unit 12, and recognizes which has been reported, the success or the failure in reception. The buffer unit 32 stores a transmitted data packet in preparation for the failure in transmission and the retransmission of the data packet. If an ACK packet indicating the success in reception is input, the ACK process unit 31 deletes the data packet specified by the received ACK packet from the buffer unit 32.

The Hello generation unit 15 generates a Hello packet for notification of the path to the node device 10 and the path recorded in the routing table 95 to the node device 10. The transmission unit 16 transmits the packets input from the Hello generation unit 15, the cluster process unit 40, the search process unit 70, and the data process unit 80 to the adjacent node.

The storage unit 90 includes the link table 91, the cluster table 92, the unaffiliation table 93, the highway table 94, the routing table 95, and a FID management table 96. The FID management table 96 is used in detecting a loop of the path through which a data packet is communicated. The data process unit 80 associates the GS of the data packet with the FID and records them in the FID management table 96. The reception process unit 30 compares the combination of the FID and the GS of the received data packet with the information recorded in the FID management table 96. If the combination of the GS and the FID of the received data packet has already been recorded in the FID management table 96, the reception process unit 30 judges that the data packet has been returned by a loop.

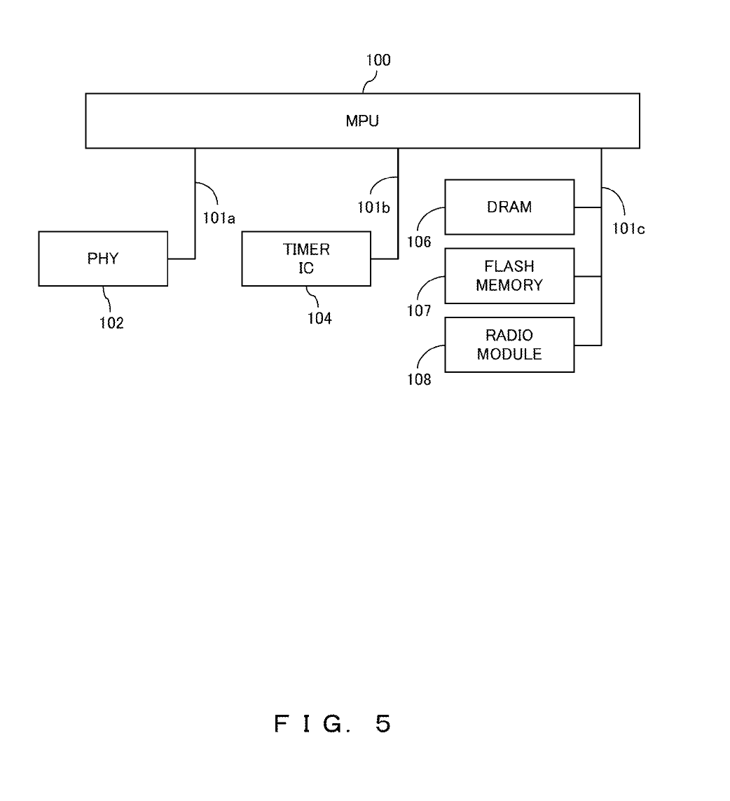

FIG. 5 is an example of a hardware configuration of the node device 10. The node device 10 includes buses 101 (101a through 101c), a physical layer (PHY) chip 102, a timer IC 104, dynamic random access memory (DRAM) 106, flash memory 107, and a radio module 108. The buses 101a through 101c are used in connecting the MPU 100, the PHY chip 102, the timer IC 104, the DRAM 106, the flash memory 107, and the radio module 108 so that data may be input and output among them.

The MPU 100 reads programs such as firmware stored in the flash memory 107 etc. and performs processing. In this case, the MPU 100 may use the DRAM 106 as working memory. The MPU 100 operates as the packet branch process unit 12, the FID generation unit 13, the upper process unit 14, the Hello generation unit 15, the Hello process unit 20, the reception process unit 30, the cluster process unit 40, the search process unit 70, and the data process unit 80. The DRAM 106 operates as the storage unit 90. The PHY chip 102 and the radio module 108 operate as the reception unit 11 and the transmission unit 16. The PHY chip 102 is an optional unit, and the node device 10 may perform communications using a cable through the PHY chip 102. For example, the node device 10 operating as a gateway between the L3 network and an ad hoc network may perform communications using a node device and the PHY chip 102 in the L3 network. The timer IC 104 is used in measuring the time taken to receive a reply packet in response to the packet transmitted by the participation request unit 51 and the generation request unit 53, and operates as a part of the participation request unit 51 and the generation request unit 53.

A program such as firmware etc. may be provided after being stored in a computer-readable storage medium, and may be installed in the node device 10. Otherwise, a program may be installed in the node device 10 by being downloaded from a network through the PHY chip 102 and the radio module 108. Furthermore, depending on the embodiments, other types of storage devices than the DRAM 106 and the flash memory 107 may be used. The node device 10 may be realized by a computer.

<Process of a Hello Packet Before Generating a Cluster>

First, before generating a cluster, the node device 10 in a network confirms an adjacent node and an unaffiliated node using a Hello packet. FIG. 4C is an example of a Hello packet. Described below is an example of notifying a node device 10b which is adjacent to the node device 10a of the information about the node device 10a by broadcasting a Hello packet from the node device 10a.

In a Hello packet, a GD and an LD are set as broadcast addresses, and a GS and an LS are set as the address of the node device 10 to which the Hello packet is to be transmitted. The value of the Type field is “0”. The payload includes a cluster field, an Sgw flag, and data. The cluster field records the cluster identifier of a cluster with which the node device 10a as a source of the Hello packet is affiliated. However, since no cluster is formed in this example, no cluster identifier is stored. The Sgw flag indicates whether or not the source node device 10a is a sub-gateway. In the following explanation, when the Sgw flag is set to “0”, it indicates that the node is not set as a sub-gateway. When the Sgw flag is set to “1”, it indicates that the node is set as a sub-gateway. Before forming a cluster, no node devices 10 are set as a sub-gateway, and therefore the value of the Sgw flag is 0. The data field records the information about the GD recorded in the routing table 95. However, before generating a cluster, the routing table 95 is not generated. Therefore, a Hello packet having the data field including no data is transmitted.

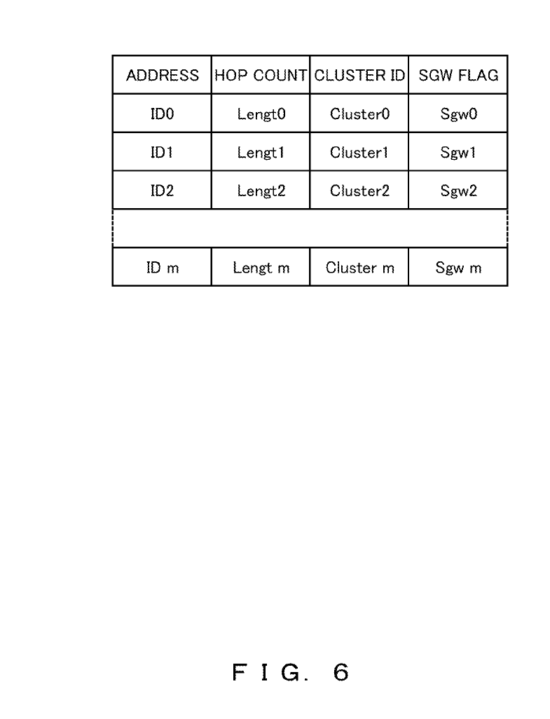

Next, the operation of the node device 10b performed when a Hello packet is received is explained below with reference to FIGS. 6 through 9. Upon receipt of the Hello packet through the packet branch process unit 12, the path management unit 21 and the unaffiliated node specification unit 22 provided for the node device 10b update the link table 91 and the unaffiliation table 93 based on the received Hello packet.

FIG. 6 is an example of the link table 91. The link table 91 records the value of the Sgw flag set for the address of an adjacent node, the cluster identifier, the hop count, and the adjacent node device for each of the adjacent node device of the node device 10. The cluster identifier in the link table 91 identifies the cluster with which the adjacent node device is affiliated. FIG. 6 is an example of the link table 91, and may have the information included in the link table 91 changed, for example, so that the link table 91 does not include a hop number etc.

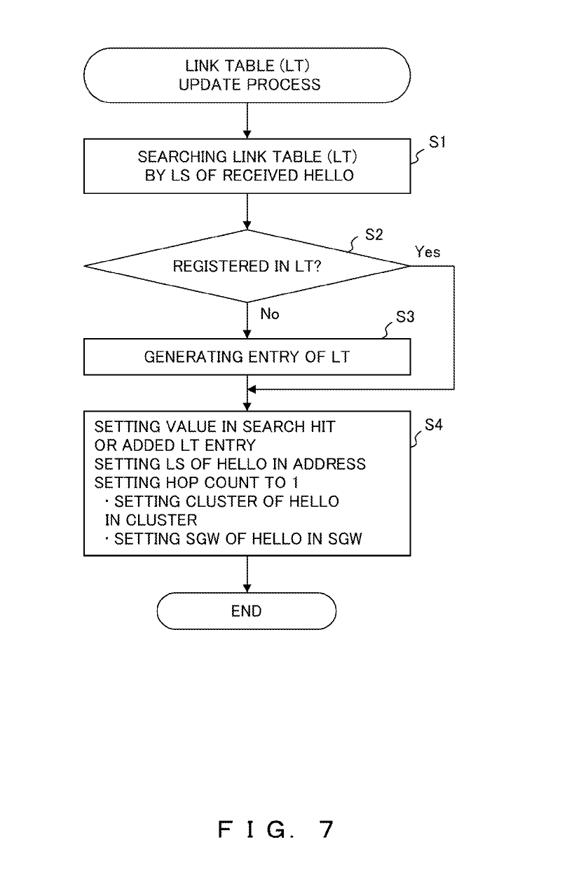

FIG. 7 is a flowchart for explanation of an example of an operation of the path management unit 21 when the link table 91 is updated. The path management unit 21 extracts the LS of the received Hello packet, and searches the column of the address of the link table 91 using the LS as a key (step S1). When the address of the LS used as a key is not registered in the link table 91, the path management unit 21 generates an entry corresponding to the LS (step S3 if NO in step S2). Next, the path management unit 21 sets the LS of the Hello packet, the cluster ID, and the value of the Sgw flag in the added entry, and records the hop count (step S4). That is, the path management unit 21 registers the LS of the Hello packet in the column of address, and sets the hop count to 1. In this case, since no cluster has been generated, the path management unit 21 initializes the value of the column of cluster ID, and sets the value of the Sgw flag to 0. On the other hand, if the address of the LS has been registered in the link table 91 in step S2, then the path management unit 21 updates the link table 91 without generating an entry (YES in step S2). In this case, the path management unit 21 performs the process in step S4 on the entry hit in the search in step S1.

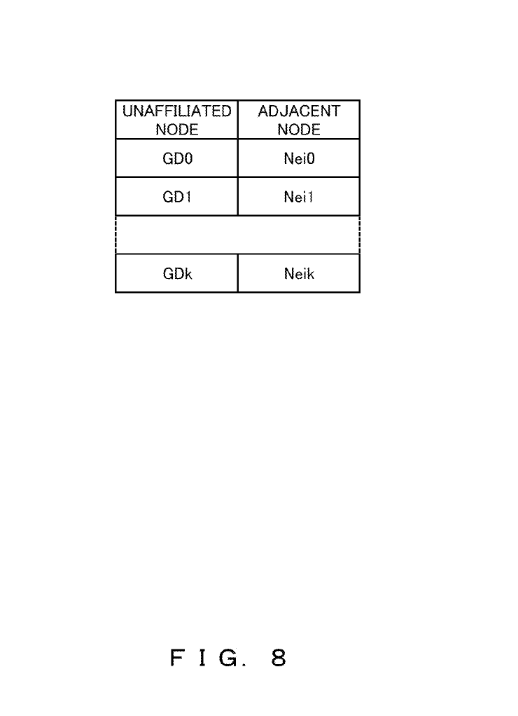

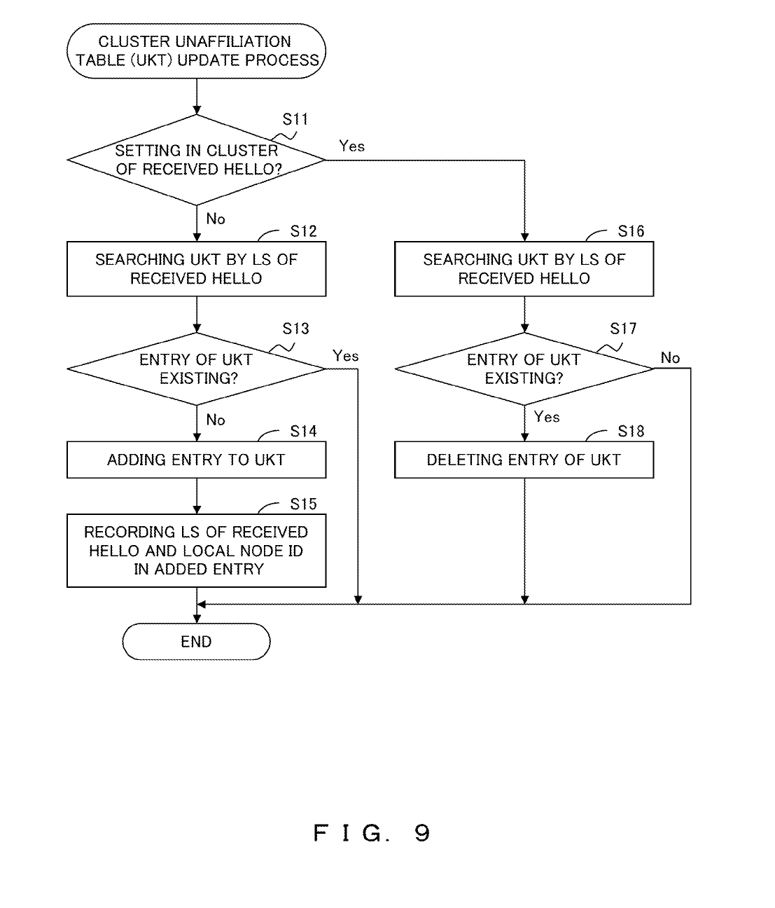

FIG. 8 is an example of the unaffiliation table 93. The unaffiliation table 93 records an unaffiliated node associated with a node adjacent to the unaffiliated node. FIG. 9 is a flowchart for explanation of an example of an operation of the unaffiliated node specification unit 22 when the unaffiliation table 93 is updated. Steps S11 through S15 are the operations performed when a Hello packet is received from the node device 10 not affiliated with a cluster. Steps S16 through S18 are the operations performed when a Hello packet is received from the node device 10 affiliated with a cluster. In this example, the process performed by the node device 10b is explained with reference to steps S11 through S15, and the process in steps S16 through 18 are described later.

The unaffiliated node specification unit 22 confirms whether or not a cluster identifier has been set in the cluster field of the received Hello packet (step S11). Unless a cluster identifier is set, the unaffiliated node specification unit 22 judges that a Hello packet has been received from the node device 10 not affiliated with a cluster, and performs the process for recording the source of the Hello packet in the unaffiliation table (UKT) 93. First, the unaffiliated node specification unit 22 extracts the LS of the received Hello packet, and searches the column of unaffiliated node of the unaffiliation table 93 using the LS as a key (step S12). If the address of the LS used as a key has not been registered in the unaffiliation table 93, the unaffiliated node specification unit 22 generates an entry corresponding to the LS (step S14 if NO in step S13). Furthermore, the unaffiliated node specification unit 22 sets the LS of the Hello packet in the unaffiliated node of the added entry, and sets the ID of the node device 10 which has received the Hello packet in the column of adjacent node (step S15). For example, when the node device 10b first receives a Hello packet from the node device 10a, the node device 10a is not recorded in the unaffiliation table 93. Therefore, the unaffiliated node specification unit 22 of the node device 10b records the node device 10a in the column of unaffiliated node of the newly generated entry, and records the node device 10b as the adjacent node to the node device 10a. On the other hand, if it is confirmed in step S13 that the address of the LS used as a key has been registered in the unaffiliation table 93, the unaffiliated node specification unit 22 terminates the process (YES in step S13).

<Generating a Cluster>

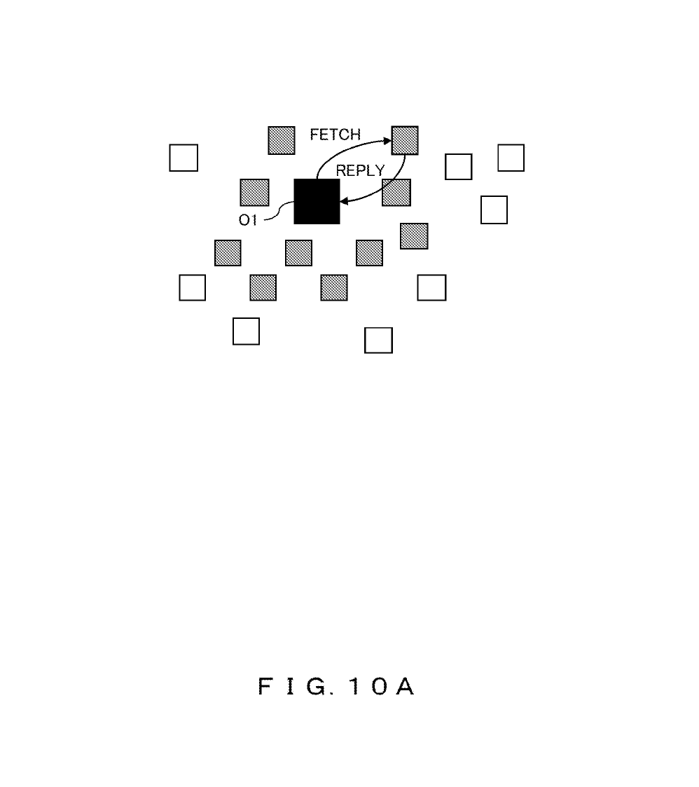

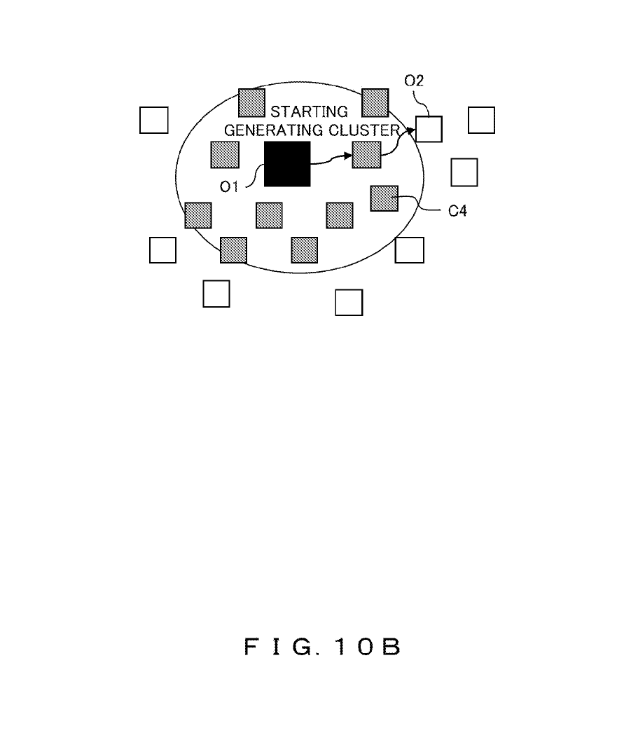

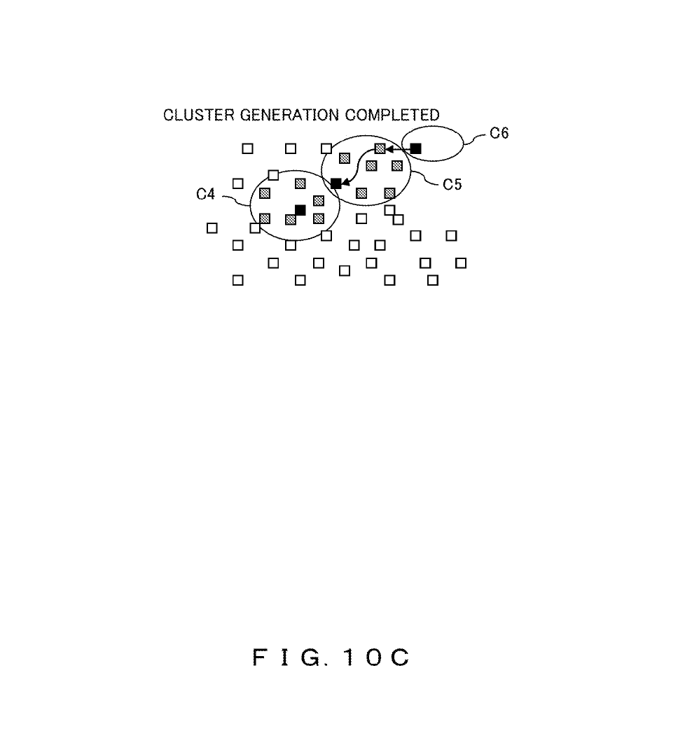

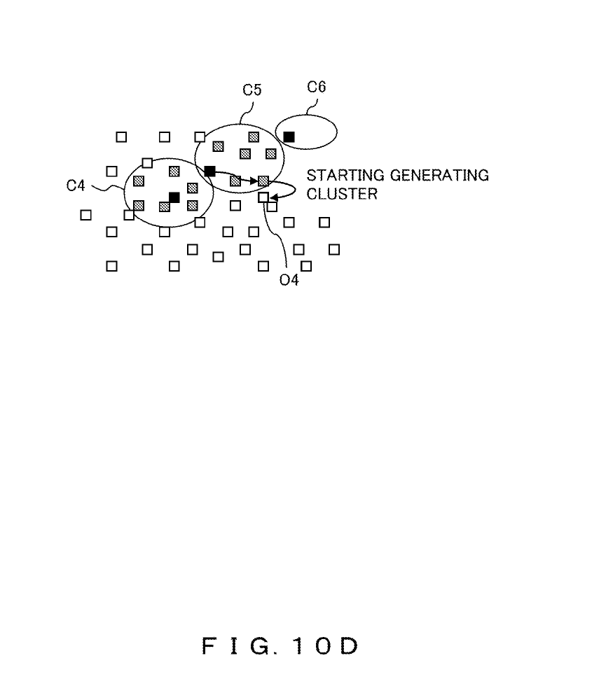

FIGS. 10A through 10D are examples of a method of generating a cluster. In the explanation below, the node device 10 which starts generating a cluster may be described as an “originating node device”. In addition, the cluster with which the node device 10 is affiliated may be described as a “local cluster” for the node device 10. Furthermore, the node device 10 affiliated with a cluster may be described as an “affiliated node”. In addition, it is assumed that an originating node device stores a threshold indicating the number of node devices 10 which may be included in advance in one cluster.

Upon recognition of an adjacent node device by the communication of a Hello packet, the originating node device starts generating a cluster including the adjacent node device. First, the participation request unit 51 in the originating node device determines the cluster identifier for identification of a cluster to be generated. Next, the originating node device is affiliated with the cluster identified by the determined cluster identifier. In the explanation below, it is assumed that the originating node device O1 generates the cluster C4.

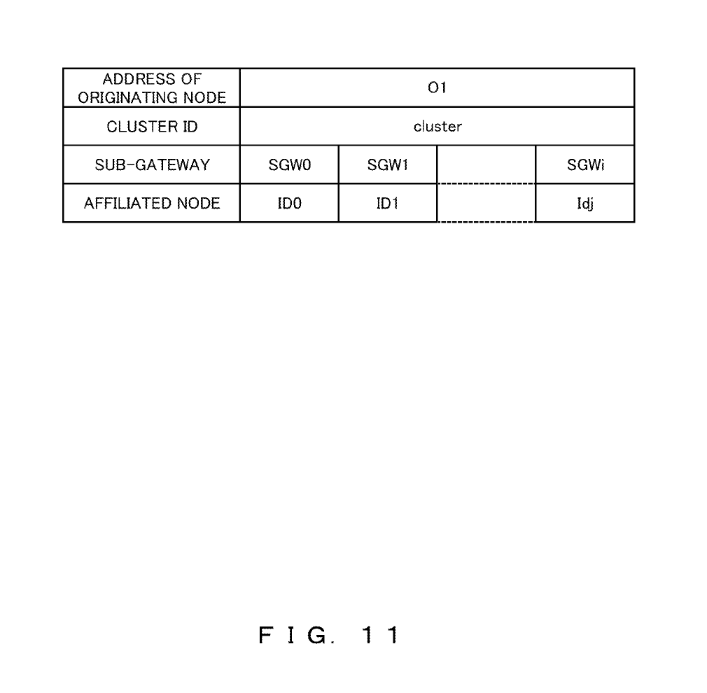

Next, as illustrated in FIG. 10A, the originating node device O1 requests the node device 10 to participate in the cluster C4 and transmits to the node device 10 a cluster identifier for identification of the cluster C4 (inclusion). Upon receipt of a request for the participation, the node device 10 is affiliated with the cluster C4 if it has not been affiliated with any cluster, and notifies the originating node device O1 of the participation in the cluster C4 (participation notification). Assume that the originating node device O1 appropriately records the information about a cluster in the cluster table 92. FIG. 11 is an example of the cluster table 92. It is assumed that the cluster table 92 records the cluster identifier of the local cluster for the node device 10 and the address of the originating node device O1. For example, in the cluster table 92 held by the originating node device O1, the cluster identifier is C4. Upon receipt of the participation notification, the originating node device O1 records the source of the participation notification as an affiliated node in the cluster table 92. The cluster table 92 also records the sub-gateway included in the local cluster, and the setting and the record of the sub-gateway are described later.

Upon receipt of the participation notification, the originating node device O1 increments the number of nodes affiliated with the cluster C4, and compares the resultant number with a threshold. If the number of the node devices 10 affiliated with the cluster C4 is smaller than the threshold, then the originating node device O1 requests another adjacent node device to participate in the cluster C4. If the total number of nodes affiliated with the cluster C4 does not reach the threshold after requesting all adjacent nodes for the participation, then the originating node device O1 requests the node devices 10 communicable through the adjacent node devices to participate in the c4. The originating node device O1 repeats requesting the participation in the cluster C4 until the number of the node devices 10 included in the cluster C4 reaches the threshold.

When the number of the nodes affiliated with the cluster C4 becomes equal to the threshold, the originating node device O1 stops requesting the participation in the cluster C4. Furthermore, as illustrated in FIG. 10B, the originating node device O1 requests the node device 10 selected from among unaffiliated nodes to operate as a new originating node device O2. Assume that the originating node device O1 notifies the originating node device O2 of the threshold when the originating node device O1 transmits a request to operate as an originating node device.

As illustrated in FIG. 10C, the originating node device O2 generates a cluster C5. The operation of the originating node device O2 when the cluster C5 is generated is the same as the operation of the originating node device O1 when the originating node device O1 generates the cluster C4. When the number of the nodes affiliated with the cluster C5 reaches the threshold, the originating node device O2 requests the originating node device O3 to generate a new cluster. When there is no unaffiliated node which the originating node device O3 requests for participation, the originating node device O3 notifies the originating node device O2 of the completion of generating a cluster. Then, the originating node device O2 requests a new originating node device O4 to generate a cluster as illustrated in FIG. 10D.

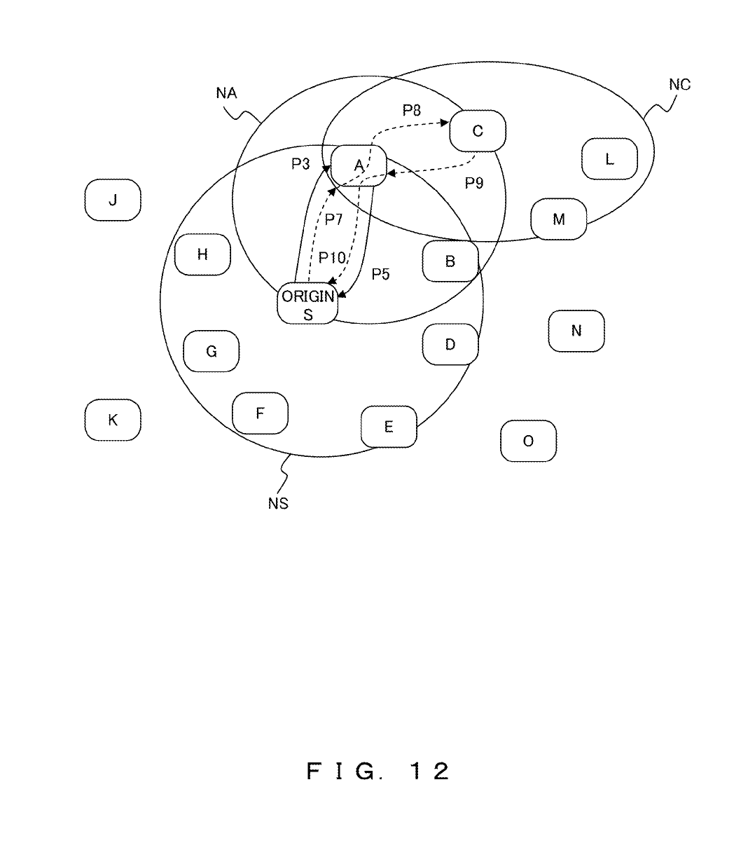

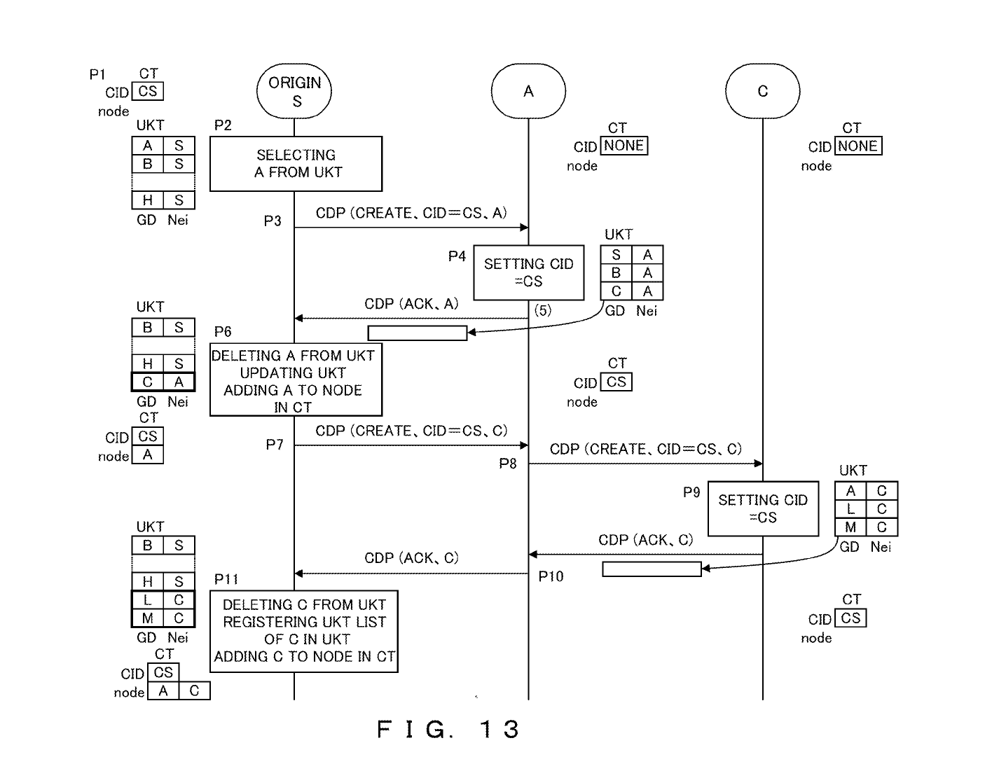

By repeating the procedures illustrated in FIGS. 10A through 10D, all node devices 10 (nodes) in the ad hoc network are affiliated with any clusters. Next, the operation of the cluster generation unit 50 is described in detail using as an example the case in which a cluster is generated in the ad hoc network illustrated in FIG. 12. Assume that the network illustrated in FIG. 12 includes 15 node devices 10, and the node S operates as an originating node device. FIG. 12 illustrates the respective adjacent nodes to the node S, the node A, and the node C. The node adjacent to the node S are those in the range of the circle NS. Similarly, the nodes adjacent to the node A are in the range of the circle NA, and the nodes adjacent to the node C are in the range of the oval NC. The threshold stored in the originating node device is 9. The reference numerals in FIG. 12 indicate the procedures explained with reference to FIG. 13.

FIG. 13 is a sequential view for explanation of an example of the process performed when a cluster is generated.

The procedure P1 is described below. When the participation request unit 51 of the node S acquires the information about an adjacent node, it starts generating the cluster CS. The participation request unit 51 registers “CS” as the cluster ID of the cluster table (CT) 92. In this case, no cluster ID is registered in the cluster table 92 in the nodes other than the node S.

The procedure 2 is described below. The participation request unit 51 of the node S refers to the unaffiliation table (UKT) 93, and selects a node to be requested to participate in the cluster CS from among the nodes registered in the unaffiliation table 93. In this example, the node A is selected. In this case, the participation request unit 51 also recognizes from the unaffiliation table 93 that the node S is adjacent to the node A (Nei).

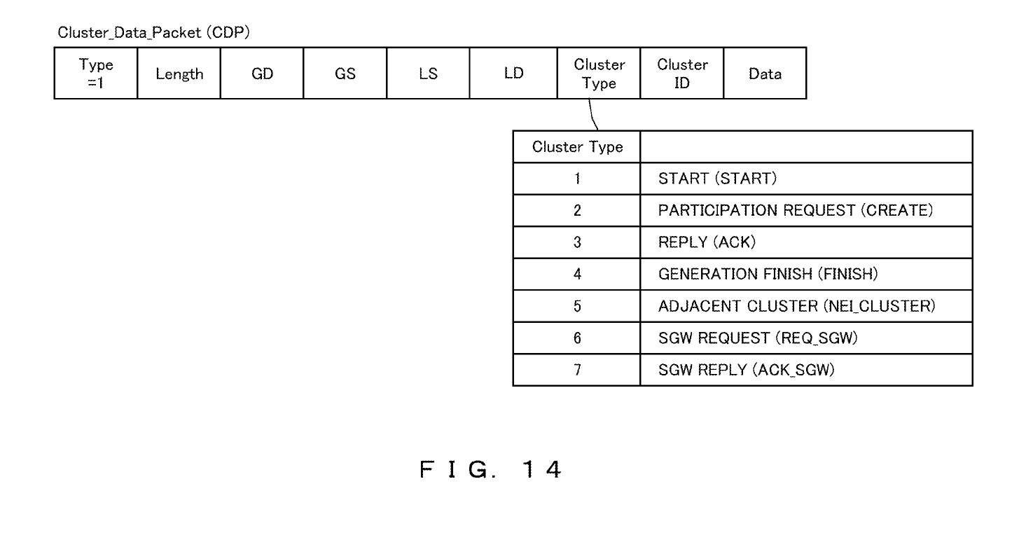

The procedure 3 is described below. The participation request unit 51 generates a cluster data packet for request for participation. FIG. 14 is an example of a configuration of a cluster data packet. In the cluster data packet, the value of the Type field is set to 1. Since the node A is adjacent to the node S, the participation request unit 51 sets the address of the node A for the GD and the LD. The participation request unit 51 also sets the address of the node S for the GS and the LS. The payload of the cluster data packet includes a cluster type field, a cluster ID field, and data. The participation request unit 51 set the value (=2) indicating the request for participation for the cluster type field, and sets CS as the identifier of the cluster CS for the cluster ID field. The participation request unit 51 transmits the generated cluster data packet to the node A through the transmission unit 16.

The procedure P4 is described below. The participation process unit 52 of the node A receives the cluster data packet transmitted from the node S through the packet branch process unit 12. The participation process unit 52 recognizes that a request for participation in a cluster has been issued by confirming the value of the cluster type field. The participation process unit 52 confirms with reference to the cluster table 92 of the node A in which cluster the node A has participated. In this example, since no cluster ID has been registered in the cluster table 92, the participation process unit 52 recognizes that the node A has not participated in any cluster. Then, the participation process unit 52 participates in the cluster CS. The participation process unit 52 sets CS in the column of the cluster ID of the cluster table 92, and records the address of the node S as the address of the originating node of the cluster CS.

The procedure P5 is described below. The participation process unit 52 of the node A generates a participation notification to be transmitted to the originating node device S. The participation process unit 52 sets the GD and the LD of the cluster data packet as the address of the node S, and also sets the GS and the LS as the address of the node A. Furthermore, “3” is set in the cluster type field. The cluster type field=3 indicates the reply message for the cluster data packet transmitted from the node set as the GS of the cluster data packet (FIG. 14). In addition, the participation process unit 52 sets the CS in the cluster ID field. Furthermore, the participation process unit 52 includes in the data field the data of the unaffiliation table 93 held by the node A. In the example in FIG. 13, the node S, the node B, and the node C are recorded in the data field as unaffiliated nodes based on the unaffiliation table 93 of the node A. When the generation of the cluster data packet is completed, the participation process unit 52 transmits the generated packet to the node S.

The procedure P6 is described below. Upon receipt of the cluster data packet from the node A, the unaffiliated node specification unit 54 of the node S confirms the value of the cluster ID field. In this example, since the value of the cluster ID field is CS, the unaffiliated node specification unit 54 recognizes that the node A is affiliated with the cluster CS. Thus, the unaffiliated node specification unit 54 deletes the extraction of the node A from the unaffiliation table 93. In addition, the unaffiliated node specification unit 54 registers the node A in the column of the affiliated node of the cluster table 92 stored in the node S.

Furthermore, the unaffiliated node specification unit 54 updates the unaffiliation table 93 using the data of the data field of the cluster data packet received from the node A. The unaffiliated node specification unit 54 confirms to which of the following items each of the nodes notified by the cluster data packet corresponds.

(α) a node operating as an originating node device

(β) a node registered in the unaffiliation table 93

(γ) a node registered in the cluster table 92

Unless each of the nodes corresponds to any of (α) through (γ), the unaffiliated node specification unit 54 registers the notified node in the unaffiliation table 93. In this example, the node S, the node B, and the node C are notified as unaffiliated nodes. However, when the unaffiliated node specification unit 54 recognizes that the node S is an originating node, it does not add the node S to the unaffiliation table 93. Furthermore, the unaffiliated node specification unit 54 compares the node recorded in the unaffiliation table 93 with the nodes B and C. Since the node B has already been registered in the unaffiliation table 93, the unaffiliated node specification unit 54 does not add the node B to the unaffiliation table 93. Since the node C is not an originating node, or has not been registered in the unaffiliation table 93, the unaffiliated node specification unit 54 registers the node C in the unaffiliation table 93. In this case, the node A which has transmitted the notification of the node C is specified as a node adjacent to the node C. FIG. 13 is an example of the registered unaffiliation table 93.

The procedure P7 is described below. The participation request unit 51 of the node S compares the number of affiliated nodes recorded in the cluster table 92 with a threshold. The number of affiliated nodes is 2 (nodes S and A) and is smaller than the threshold. Therefore, the participation request unit 51 selects the node to be requested to newly participate in the cluster CS from the unaffiliation table 93. The participation request unit 51 selects the node C as the node to be requested for participation, and recognizes that the node A is adjacent to the node C.

Then, the participation request unit 51 generates a cluster data packet for a participation request. In this case, the address of the node C is set as the GD, the address of the node A is set as the LD, and the address of the node S is set as the S and the LS. The payload of the cluster data packet is the same as the that of the cluster data packet generated in the procedure P3. The participation request unit 51 transmits the generated cluster data packet to the node A.

The procedure P8 is described below. The node A receives the packet transmitted in the procedure P7. Since the address of the node C is set for the GD, the participation process unit 52 recognizes that the received packet is not addressed to the node A. Then, the participation process unit 52 changes the LS in the header of the received packet to the address of the node A, changes the LD to the address of the node C, and then transmits the packet to the node C. Before generating the routing table 95, it is assumed that the participation process unit 52 has forwarded a cluster data packet using the link table 91 appropriately.

The procedure P9 is described below. Upon receipt of a packet, the participation process unit 52 of the node C performs a process similar to the process in the procedure P4. Furthermore, the participation process unit 52 generates a cluster data packet to be transmitted to the node (originating node device) set as the GS of the cluster data packet. The participation process unit 52 sets the GD of the cluster data packet as the address of the node S, sets the LD as the address of the node A, and further sets the GS and the LS as the address of the node C. The information about the payload is similarly generated as in the procedure P5. In this example, the node A, the node L, and the node M are recorded in the data field as unaffiliated nodes based on the unaffiliation table 93 of the node C. The generated cluster data packet is transmitted to the node A.

The procedure P10 is described below. Upon receipt of the cluster data packet from the node C, the participation process unit 52 of the node A confirms the GD. Since the node S is specified as the GD, the participation process unit 52 changes the LS in the header of the received packet as the address of the node A, changes the LD to the address of the node S, and transmits the packet to the node S.

The procedure P11 is described below. The unaffiliated node specification unit 54 of the node S similarly processes the received cluster data packet as in the procedure P6. That is, the unaffiliated node specification unit 54 deletes the entry of the node C from the unaffiliation table 93, and registers the node C in the column of the affiliated node of the cluster table 92. Furthermore, the unaffiliated node specification unit 54 retrieves the node to be registered in the unaffiliation table 93 from among the unaffiliated nodes notified from the node C. In this example, since the node A has already been registered in the cluster table 92, the unaffiliated node specification unit 54, the unaffiliated node specification unit 54 registers the nodes L and M in the unaffiliation table 93. The node C is registered as a node adjacent to the nodes L and M.

The node S may define all adjacent nodes as the nodes affiliated with the cluster CS by repeating the processes in the procedures P2 through P6 on the adjacent nodes other than the node A. Furthermore, the procedures explained above with reference to FIG. 13 is an example only, and may be changed depending on the implementation. For example, the originating node device may request the node adjacent to the originating node device for participation on a priority basis, and after completing the request for participation, the originating node device may request another node than the adjacent node for participation.

Assume that the nodes A through H and the node Shave participated in the cluster CS by the processes described above with reference to FIGS. 12 and 13. Then, the number of nodes affiliated with the cluster CS is 9, and reaches the threshold. If the number of affiliated nodes matches the threshold, the participation request unit 51 stops the process, and conforms whether or not there is a registered node in the unaffiliation table 93. When there is no node registered in the unaffiliation table 93, the participation request unit 51 recognizes that the generation of a cluster has been completed. On the other hand, if a node affiliated with the unaffiliation table 93 is registered, then the participation request unit 51 notifies the generation request unit 53 that the number of affiliated nodes has reached the threshold and there is an affiliated node. Upon receipt of the notification from the 51, the generation request unit 53 specifies a new originating node device.

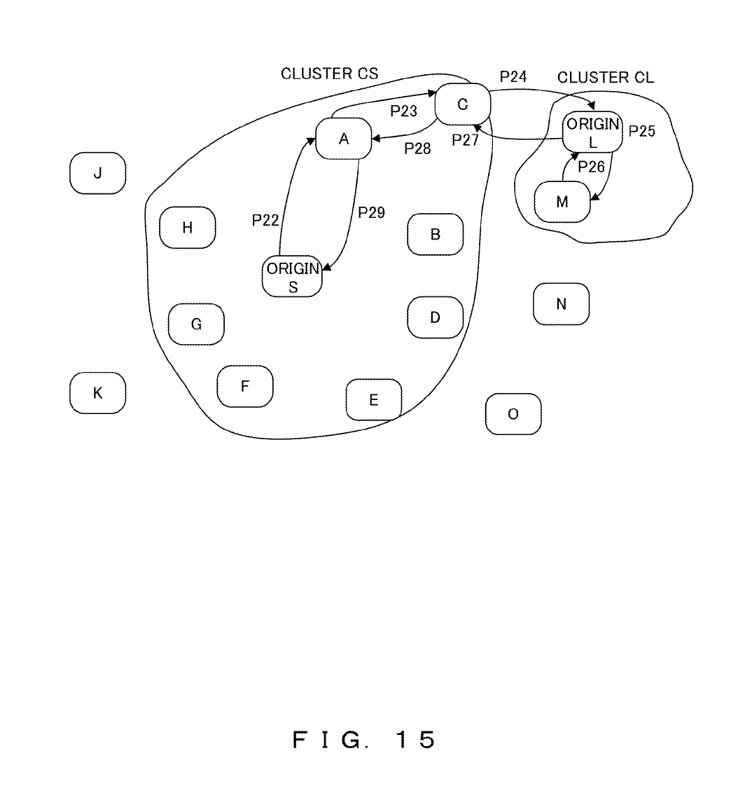

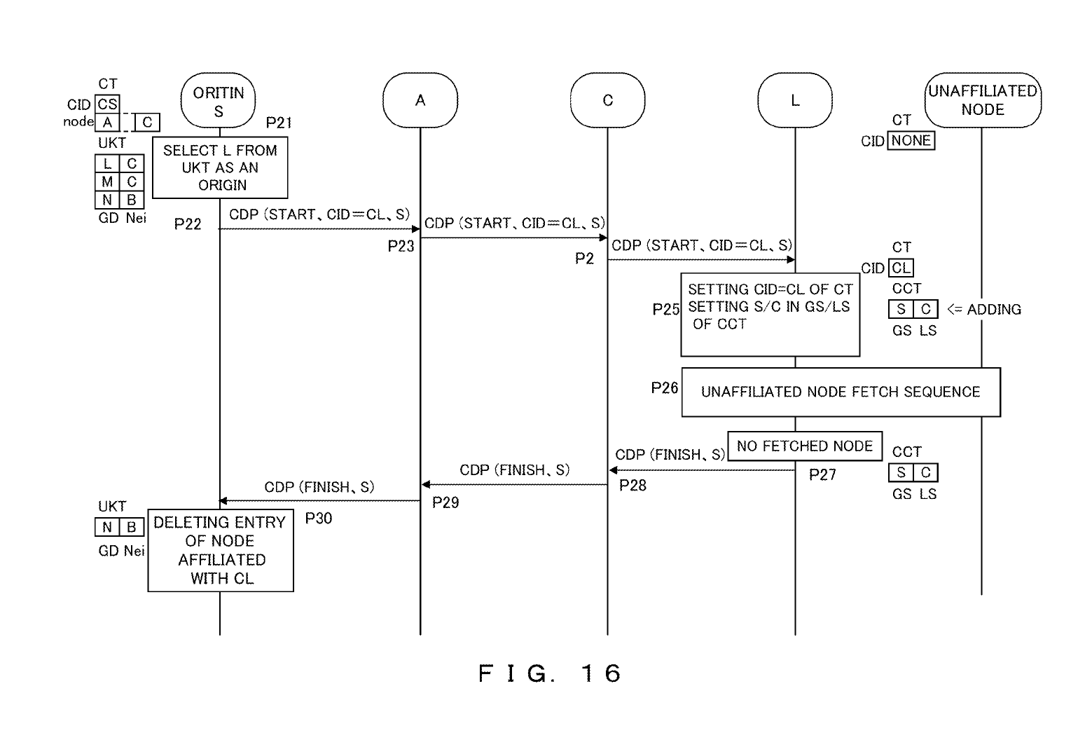

FIG. 15 is an example of specifying a new originating node device and generating a cluster. FIG. 16 is a sequential view for explanation of an example of a communication performed when a new originating node device is specified and a cluster is generated. The reference numerals in FIG. 15 indicate those in the procedure in the explanation in FIG. 16.

The procedure P21 is described below. The generation request unit 53 of the node S is reported from the participation request unit 51 that there is an unaffiliated node remaining although the number of the nodes affiliated with the cluster CS generated by the node S has reached the threshold. Then, the generation request unit 53 confirms the unaffiliation table 93, and determines a node to be specified as a new originating node. In this example, it is assumed that the generation request unit 53 has specified the node L as a new originating node.

The procedure P22 is described below. The generation request unit 53 generates the cluster data packet to be set for an originating node. When a request to generate a new cluster is made, the value of the cluster type field of the cluster data packet is set to “1”. Furthermore, the generation request unit 53 sets the header of the cluster data packet. In addition, the generation request unit 53 includes in the data field of the cluster data packet the information for identification of the node through which the cluster data packet passes.

As described later, when a cluster is formed, the routing table 95 is generated by the Hello packet communicated between the node devices 10 affiliated with the cluster. The routing table 95 holds the path to the node device 10 in the local cluster. Then, the generation request unit 53 sets the address using the data of the routing table 95 about the path to the node adjacent to the address of the cluster data packet. For example, it is recognized that the node L as the destination is adjacent to the node C from the unaffiliation table 93. It is recorded on the routing table 95 that the packet addressed to the node C may be transmitted through the node A. Then, the generation request unit 53 specifies the node C as the GD, the node A as the LD, and the node C as the GS and the LS. Furthermore, the generation request unit 53 records the node L as the destination for the start of generation in the cluster ID field. The generation request unit 53 transmits the generated cluster data packet to the node A.

The procedure P23 is described below. Upon receipt of the cluster data packet which is addressed to another node and whose cluster type field is set to “1”, the participation process unit 52 of the node A refers to the GD field. The participation process unit 52 forwards the cluster data packet toward the node recorded in the GD field. Since the information about the node C is included in the GD field in this example, the generation request unit 53 changes the LS of the cluster data packet to the node A, and the LD to the node C, and transmits the packet to the node C.

The procedure P24 is described below. The participation process unit 52 of the node C changes the LS of the cluster data packet received from the node A to the node C, the LS to the node L, and the GD to the node L recorded in the cluster ID field of the cluster data packet, and then transmits the packet to the node L. In this case, the participation process unit 52 performs the forwarding process by referring to the link table 91.

The procedure P25 is described below. Upon receipt of the cluster data packet from the node S, the participation request unit 51 of the node L starts generating the cluster CL. The participation request unit 51 registers “CL” as the cluster ID of the cluster table (CT) 92 of the node L. Furthermore, the participation request unit 51 records the GS and the LS of the packet which has requested to start generating a cluster in the cluster creation table (CCT) 42. In this example, the address of the node S is recorded as a GS, and the address of the node C is recorded as the LS.

The procedure P26 is described below. The participation request unit 51 determines the node to be requested to participate in the cluster CL based on the unaffiliation table 93. In the example illustrated in FIG. 15, the node L requests the node M to participate in the cluster CL. In the example illustrated in FIG. 15, the node L requests the node M to participate in the cluster. The operation performed when the participation request is made is similar to the operation explained above with reference to FIGS. 12 and 13.

The procedure P27 is described below. When there is no unaffiliated node in the unaffiliation table 93, the participation request unit 51 notifies the GS recorded in the cluster creation table 42 using the cluster data packet (termination notification message) that the generation of the cluster has been completed. In this case, the participation request unit 51 records the list of the nodes affiliated with the generated cluster in the data field of the completion notification message. In this example, the participation request unit 51 of the node L notifies the generated cluster that the nodes L and M are included.

In the header of the cluster data packet for notification of the completion of the generation, the address of the GS recorded in the cluster creation table 42 as the GD is specified. In this example, the node L notifies the node S of the completion of the generation of a cluster. In the completion notification message, the value of the cluster type field is set to “4”, and the cluster ID is set to “CL”. The participation request unit 51 of the node L transmits the generated packet to the node C. Furthermore, after transmitting the completion notification message, the participation request unit 51 deletes the entry of the cluster creation table 42.

The procedure P28 is described below. When the participation process unit 52 of the node C recognizes that the GD of the cluster data packet received from the node L is the node S, the participation process unit 52 forwards the cluster data packet using the routing table 95. In this case, the participation process unit 52 sets the LS of the cluster data packet as the address of the node C, and the LD as the address of the node A, and then transmits the packet to the node A.

The procedure P29 is described below. The participation process unit 52 of the node A also performs the process of forwarding a cluster data packet using the routing table 95. When the participation process unit 52 recognizes that the GD of the cluster data packet is the node S, it sets the LS of the packet as the address of the node A, and the LD as the address of the node S, and then transmits the packet to the node S.

The procedure P30 is described below. The generation request unit 53 receives from the node A a completion notification message generated in the node L. Then, the generation request unit 53 deletes the entry of the node L. Furthermore, the generation request unit 53 deletes the entry from the unaffiliation table 93 for the node recorded in the data field of the generation completion notification. In this example, the entries of the nodes L and M are deleted from the unaffiliation table 93.

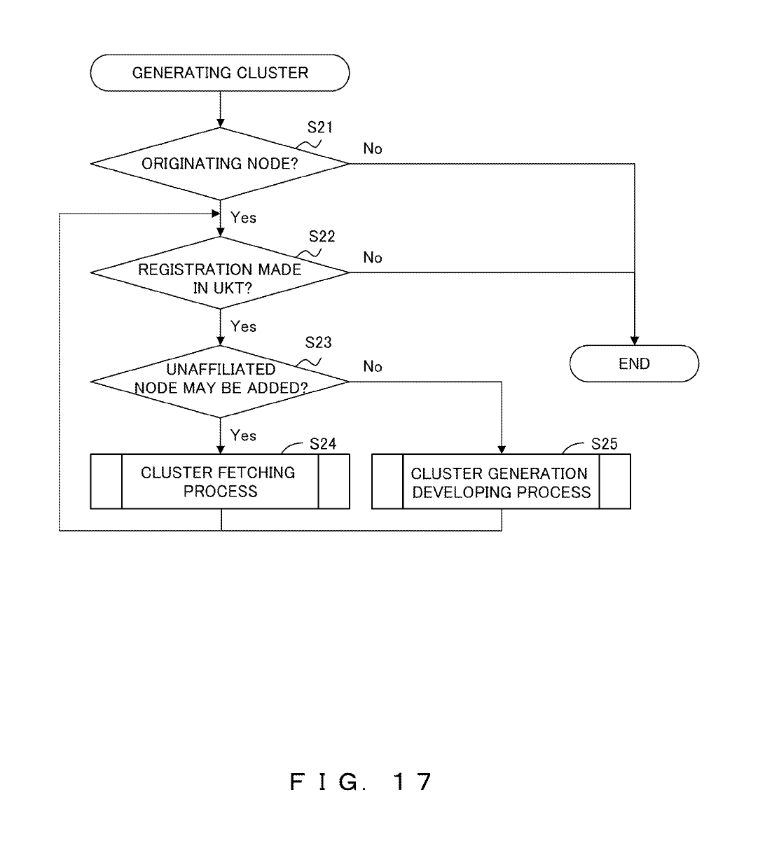

FIG. 17 is a flowchart for explanation of an example of the procedure of generating a cluster. The participation request unit 51 as an originating node starts generating a cluster (step S21). The participation request unit 51 confirms whether or not there is any registration in the unaffiliation table (UKT) 93 (YES in step S21). When an unaffiliated node is registered in the unaffiliation table 93, the participation request unit 51 confirms whether or not a new node may be added to the cluster by comparing the number of affiliated nodes in the generated cluster with the threshold (step S34 after YES in step S22). When a new node may be added to a cluster, the participation request unit 51 issues a participation request to the cluster (step S24 after YES in step S23). When a new node is not to be added to the cluster, the participation request unit 51 requests the generation request unit 53 to generate a new cluster (step S25 after NO in step S23). On the other hand, when it is judged in step S22 that no unaffiliated node has been registered in the unaffiliation table 93, the participation request unit 51 terminates the process (NO in step S22). Furthermore, in the node judged in step S21 as no originating node, the process is terminated (NO in step S21).

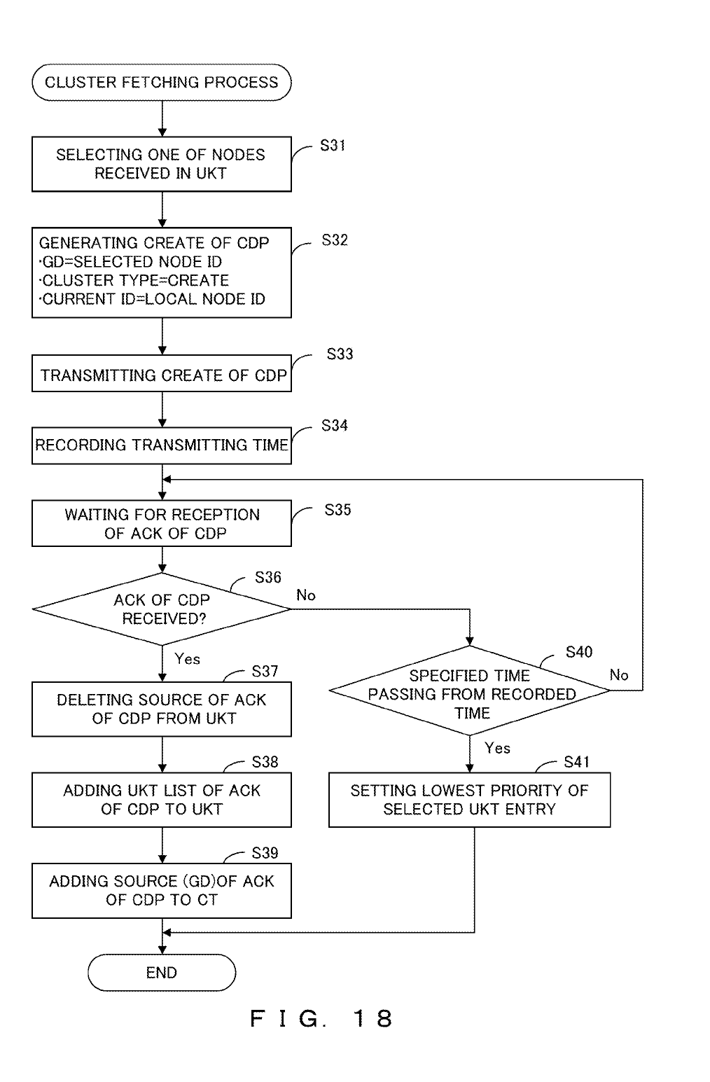

FIG. 18 is a flowchart for explanation of an example of an operation performed when an unaffiliated node is requested to participate in a cluster. The flowchart in FIG. 18 is an example. For example, the order of steps S37 through S39 may be optionally changed. Furthermore, step S41 is an optional step, and may be omitted depending on the performance of the node device 10.

The participation request unit 51 selects one of the unaffiliated nodes recorded in the unaffiliation table 93, and generates a cluster data packet (steps S31 and S32). In this case, the address of the node selected in step S31 is specified as the GD of the cluster data packet. The value of the cluster type field is set to 2 (CREATE). Furthermore, the cluster ID stores the ID of the cluster generated by the participation request unit 51. The participation request unit 51 transmits the generated cluster data packet, and records the transmission time (steps S33 and S34). Until the participation notification message (ACK) of the cluster data packet is received, the unaffiliated node specification unit 54 enters a standby state (steps S35 and S36). Upon receipt of the participation notification message, the unaffiliated node specification unit 54 deletes the entry of the source node of the participation notification message from the unaffiliation table 93 (step S37 after YES in step S36). Furthermore, when the data of the participation notification message includes the information about an unaffiliated node, the unaffiliated node specification unit 54 adds the obtained information about the node to the unaffiliation table 93 (step S38). In addition, the unaffiliated node specification unit 54 adds the source of the participation notification message to the cluster table 92 (step S39).

On the other hand, if the unaffiliated node specification unit 54 judges in step S36 that the participation notification message has not been received, then the unaffiliated node specification unit 54 confirms whether or not the elapsed time from the transmission time of the cluster data packet for request for participation is longer than a specified time (step S40 after NO in step S36). If a specified time has not passed, the processes in and after step S35 are repeated. If the participation notification message is not received after the lapse of a specified time, the node requested for participation is assigned a lower priority when a node is next selected from the unaffiliation table 93 (step S41).

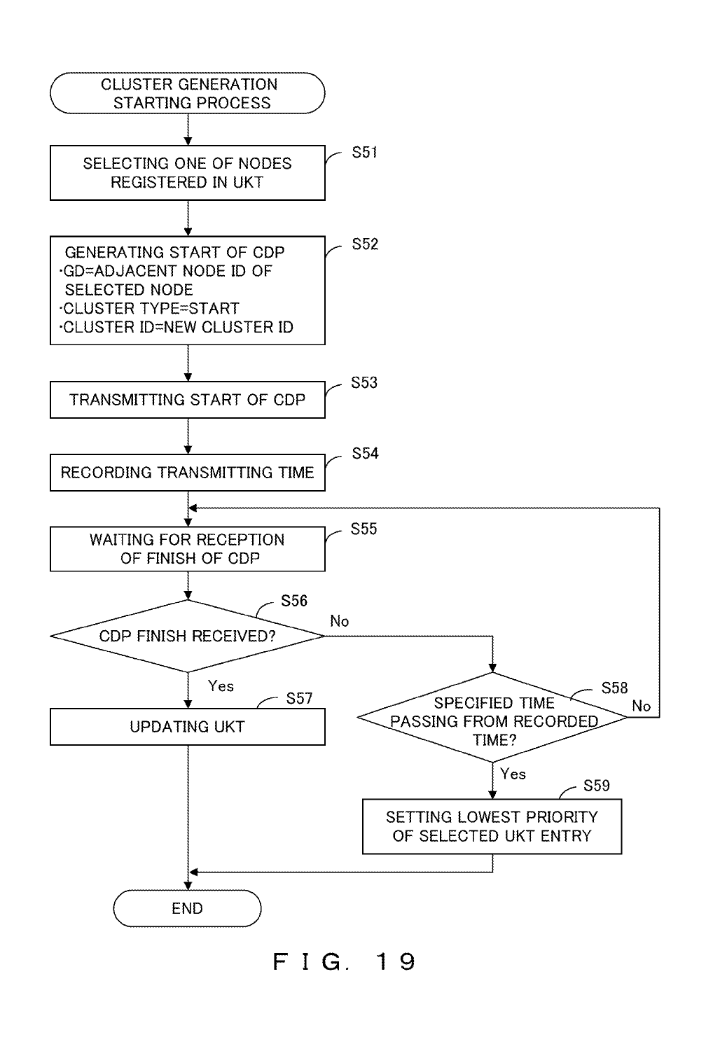

FIG. 19 is a flowchart for explanation of an example of the operation performed when a new cluster is generated. For example, a change may be added by omitting step S59 depending on the performance of the node device 10.

The generation request unit 53 selects one of the unaffiliated nodes registered in the unaffiliation table 93 (step S51). The generation request unit 53 generates a cluster data packet to be transmitted to the selected unaffiliated node (step S52). In this case, the address of the node adjacent to the unaffiliated node selected in step S51 is specified as the GD of the cluster data packet. Furthermore, the value of the cluster type field is set to 1 (START). The cluster ID for identification of the cluster to be newly generated is recorded. Assume that the node device 10 as a new originating node may be uniquely identified by the cluster ID. The generation request unit 53 transmits the generated cluster data packet, and records the transmission time (steps S53 and S54). Until the reception of the completion notification message (FINISH) of the cluster data packet, the generation request unit 53 enters a standby state (steps S55 and S56). Upon receipt of the completion notification message, the generation request unit 53 deletes the entry of the source node of the completion notification message from the unaffiliation table 93 (step S57 after YES in step S56). Furthermore, the generation request unit 53 also deletes from the unaffiliation table 93 the node affiliated with the generated cluster based on the cluster data packet transmitted in step S53.

On the other hand, if the generation request unit 53 judges in step S56 that the participation notification message has not been received, the generation request unit confirms whether or not the elapsed time from the transmission time of the cluster data packet for requesting the generation of a cluster is longer than a specified time (step S58 after NO in step S56). If the specified time has not passed, the processes in and after step S55 are repeated (NO in step S58). If the completion notification message is not received after the specified time passes, the node requested for the generation of a cluster is assigned a lower priority when a node is next selected from the unaffiliation table 93 (step S59 after YES in step S58).

<Process of Hello Packet after Affiliation with Cluster>

During and after generation of a cluster, a Hello packet is communicated between the node devices 10. Described below is the process of a Hello packet when any node device 10 is not set as a sub-gateway after starting the generation of a cluster. The process performed after setting a sub-gateway is described later.

The operation of the node device 10 depends on whether or not the node device 10 which has received a Hello packet is affiliated with a cluster. The operation performed when the node device 10 not affiliated with a cluster receives a Hello packet is described above with reference to FIGS. 6 through 9. On the other hand, in the node device 10 affiliated with a cluster, the routing table 95 and the cluster table 92 may be updated using a Hello packet. Furthermore, the node device 10 affiliated with a cluster may include in the data field of the Hello packet the path information about the routing table 95 stored in the node device 10.

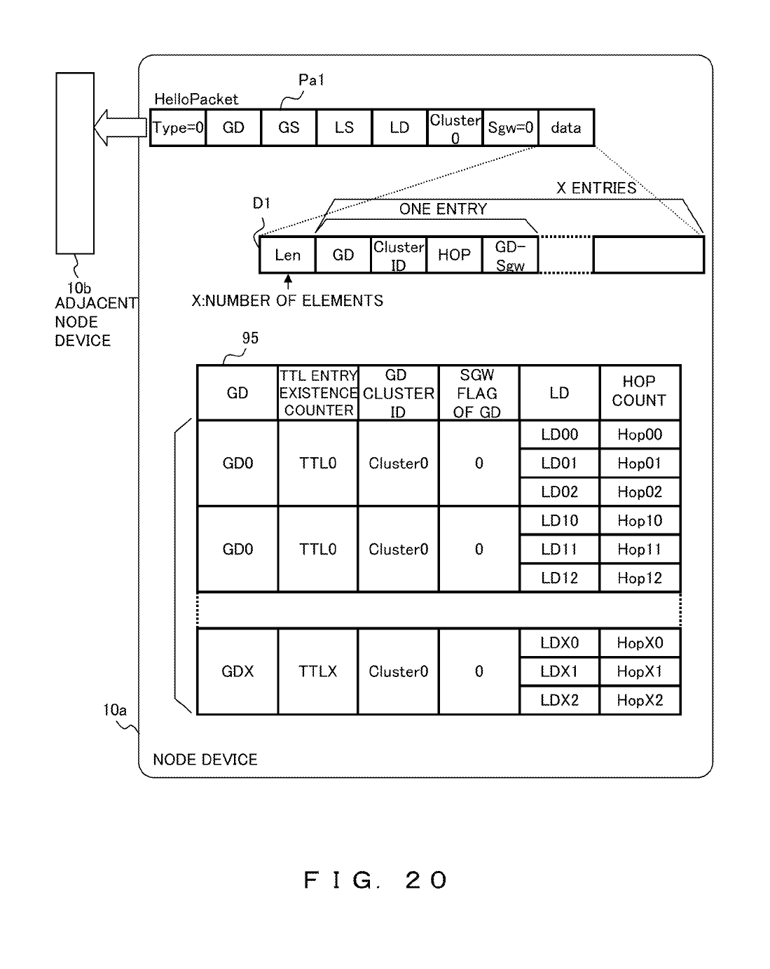

FIG. 20 is an example of generating a Hello packet in the node device 10a affiliated with a cluster. Pa1 in FIG. 20 indicates an example of the format of a Hello packet. D1 in FIG. 20 indicates an example of the format of a data field. The data field includes the information about the GD. The number of GDs included in the data field is recorded in the Len field. The Hello generation unit 15 of the node device 10a reads the cluster ID, the hop count, and the value of the Sgw flag for the GD recorded in the routing table 95, and includes them in the data.

FIG. 20 is an example of the routing table 95. The routing table 95 records for each GD the value of a TTL (Time to Live) entry existence counter, the GD cluster ID, the value of the GD-Sgw flag, and the LD. In this example, the “GD-Sgw flag” indicates the value of the Sgw flag recorded after associated with the GD on the routing table 95. Since no node device 10 is specified for the sub-gateway in this example, the value of the GD-Sgw flag is 0 in each node. The value of the TTL entry existence counter is reduced depending on the elapsed time from the update of the record on the GD, and indicates that the information about the GD is valid when the value of the TTL entry existence counter is positive. The GD cluster ID is an identifier for identification of a cluster with which the GD is affiliated. In the example illustrated in FIG. 20, for each GD, three LDs are set by the node device 10 to transmit a packet to the GD, and the hop count is recorded depending on each LD.

The Hello generation unit 15 acquires the value recorded in the routing table 95 for each of the GD, the cluster identifier, the GD-Sgw flag, and the hop count, and set the value as data. In this case, the Hello generation unit 15 include in the data the hop count associated with the LS used as the first candidate when transmitting a packet from the node device 10a to the GD.

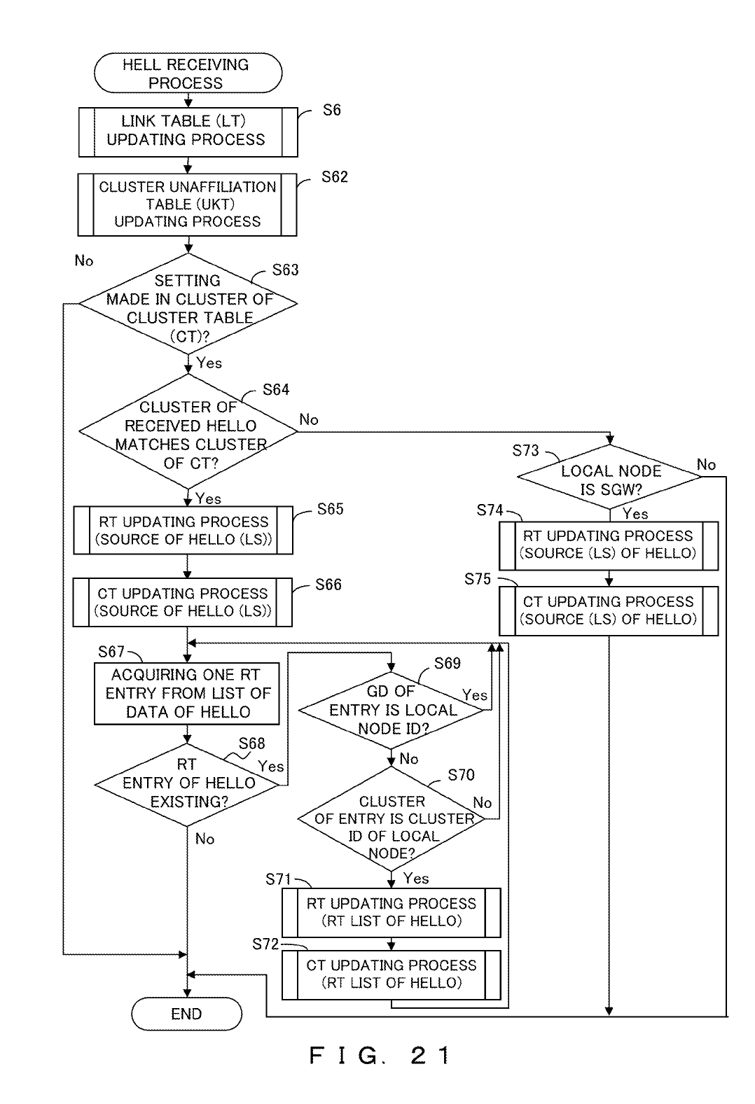

FIG. 21 is a flowchart for explanation of an example of an operation performed when the node device 10 receives a Hello packet. In this case, an example of the case in which the node devices 10b and 10c receive a Hello packet broadcast from the node device 10a is explained with reference to FIG. 21. Assume that the node devices 10a and 10b are affiliated with a cluster, and the node device 10c is an unaffiliated node. FIG. 21 is an example of an operation, and a change of, for example, the order of steps S65 and S66, the order of steps S71 and S72, etc. may be made.

Upon receipt of a Hello packet, the node devices 10b and 10c update the link table 91 and the unaffiliation table 93 (steps S61 and S62). Step S61 is similar to the operation of steps S16 through S18. Since the cluster is reported by the Hello packet transmitted from the node device 10a, the node devices 10b and 10c searches the column of an unaffiliated node of the unaffiliation table 93 using the LS in the Hello packet as a key (step S16 after YES in step S11). If an unaffiliated node is hit, the unaffiliated node specification unit 22 deletes the entry of the hit node (steps S17 and S18).

Next, the node device 10 confirms whether or not a cluster ID is recorded in the cluster table 92 (step S63). The node device 10c not affiliated with a cluster terminates the process (NO in step S63).

The node device 10b affiliated with a cluster compares the cluster identifier recorded in the cluster table 92 with the cluster identifier in the Hello packet (step S64).

If they match each other, the path management unit 21 of the node device 10b updates the routing table 95 for the node device 10a (the LS of the Hello packet) (step S65 after YES in step S64). The path management unit 21 also performs the process for updating the cluster table 92 (step S66).

The path management unit 21 of the node device 10b acquire one unprocessed entry from the list included in the data field of the Hello packet (steps S67 and S68). If no valid value is recorded in the unprocessed entry, the path management unit 21 terminates the process (NO in step S68).

On the other hand, when the unprocessed entry is acquired, the path management unit 21 confirms whether or not the GD of the acquired entry matches the address of the node device 10b (the node device 10 provided with the path management unit 21) (step S69 after YES in step S68). If the GD of the acquired entry matches the address of the node device 10b, the path management unit 21 processes another entry without updating the routing table 95, thereby returning control to step S67 (YES in step S69). On the other hand, if the GD of the acquired entry does not match the address of the node device 10b, the path management unit 21 further confirms whether or not the cluster ID recorded for the acquired entry is the cluster ID for identification of the cluster with which the node device 10b is affiliated (step S70). If the cluster ID recorded for the acquired entry is the cluster ID for identification of the cluster with which the node device 10b is affiliated, then the path management unit 21 updates the routing table 95 and the cluster table 92 (steps S71 and S72 after YES in step S70). Then, the path management unit 21 repeats the processes in and after step S67. On the other hand, unless the cluster ID recorded for the acquired entry is the cluster ID for identification of the cluster with which the node device 10b is affiliated, then the path management unit 21 repeats the processes in and after step S67 (NO in step S70).

In step S64, if the cluster identifier recorded in the cluster table 92 does not match the cluster identifier in the Hello packet, the path management unit 21 of the node device 10b confirds whether or not the node device 10b is a sub-gateway (step S73). Unless the node device 10 is a sub-gateway, the node device 10b terminates the process (NO in step S73). If the node device 10b is a sub-gateway, the routing table 95 and the cluster table 92 are updated (steps S74 and S75). The operation performed when the node device 10b is a sub-gateway is described later.

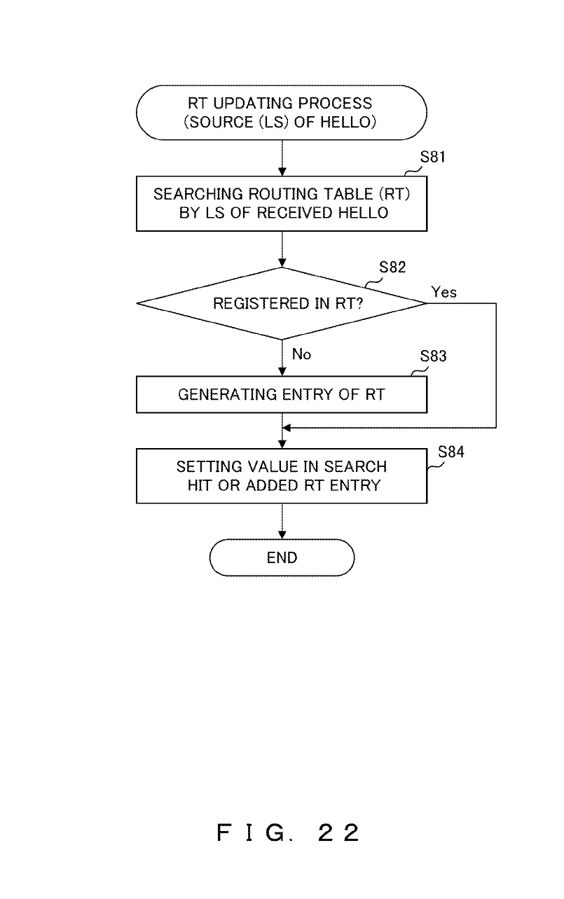

FIG. 22 is a flowchart for explanation of an example of an operation performed to update the routing table 95. FIG. 22 illustrates in detail the process in step S65 in FIG. 21. The path management unit 21 of the node device 10b searches the column of the GD of the routing table 95 using the address registered in the LS of the Hello packet as a key, thereby confirming whether or not the path to the LS has already been registered (steps S81 and S82). Unless the path to the LS of the Hello packet has been registered, the path management unit 21 generates a new entry in the routing table 95, and records the value corresponding to the LS for the generated entry (steps S83 and S84 after NO in step S82). On the other hand, if the path to the LS of the Hello packet has been registered, the path management unit 21 updates the value of the entry obtained by the search to the value notified by the Hello packet (step S84 after NO in step S82).

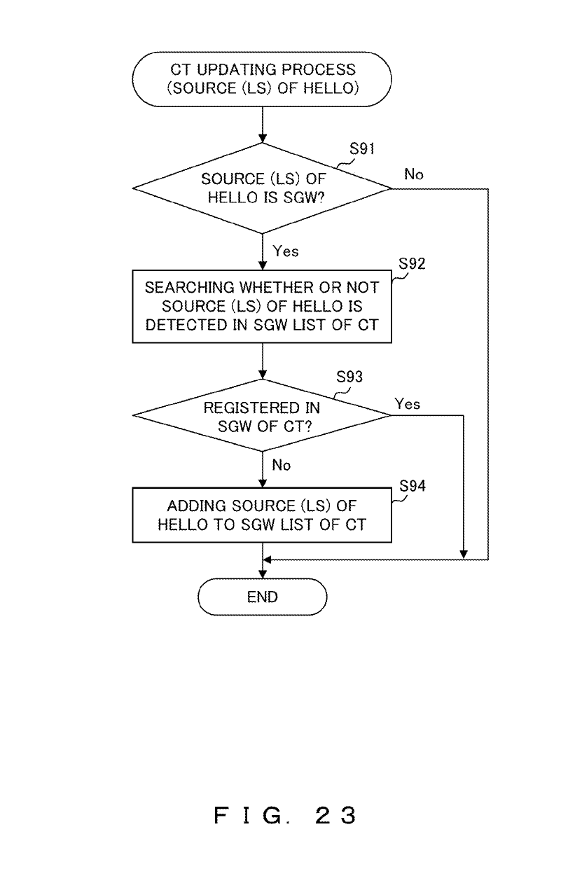

FIG. 23 is a flowchart for explanation of an example of an operation performed to update the cluster table 92. FIG. 23 illustrates in detail the process in step S66 in FIG. 21. As indicated by step S91 in FIG. 23, when the source node device 10 of the Hello packet is not a sub-gateway, the cluster table 92 is not updated. In this example, since the node device 10a is not set as a sub-gateway, the path management unit 21 of the node device 10b does not update the cluster table 92, thereby terminating the process. The case in which the source of the Hello packet is a sub-gateway is described later.

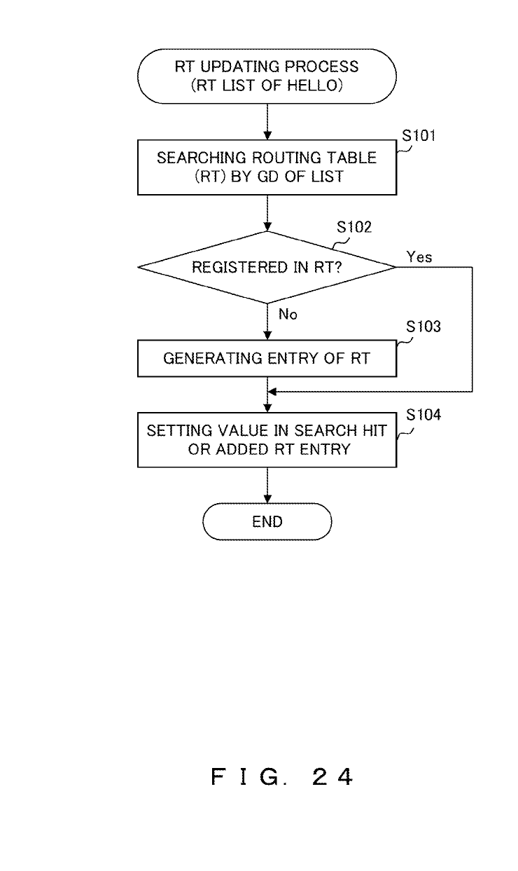

FIG. 24 is a flowchart for explanation of an example of an operation performed to update the routing table 95. FIG. 24 illustrates in detail the process in step S71 in FIG. 21. The path management unit 21 of the node device 10b searches the column of the GD of the routing table 95 using the address registered in the GD of the data field as a key (step S101). The processes in steps S102 through S104 are similar to the processes in steps S82 through S84 explained above with reference to FIG. 22.

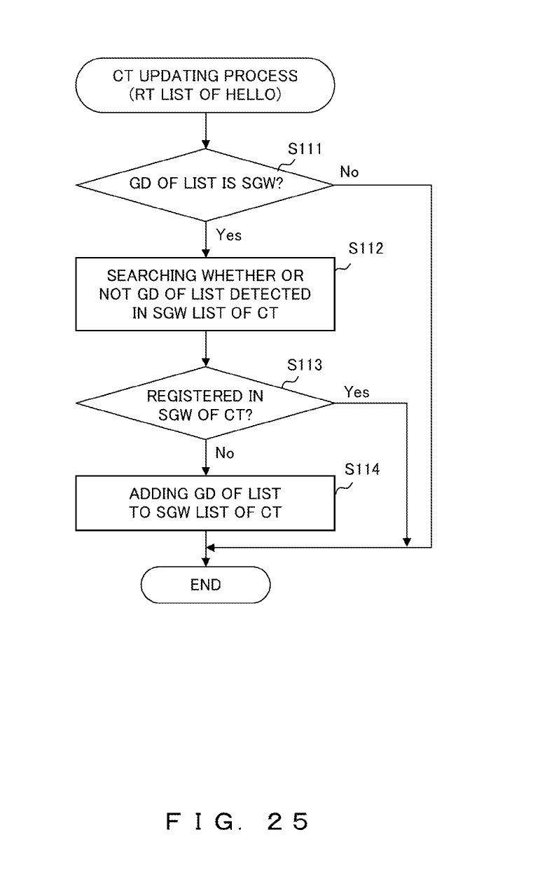

FIG. 25 is a flowchart for explanation of an example of an operation performed to update the cluster table 25. FIG. 25 illustrates in detail the process in step S72 in FIG. 21.

As illustrated in step S111 in FIG. 25, when the GD recorded in the data field of the Hello packet is not a sub-gateway, the cluster table 92 is not updated. In this example, since the setting of a sub-gateway has not been started, the path management unit 21 of the node device 10b does not update the 92, thereby terminating the process. The case in which the GD in the data field is a sub-gateway is described later.

By the process in steps S68 through S72 in FIG. 21, the node device 10b updates the routing table 95 according to the information acquired from the Hello packet when the information about the affiliated node of the cluster with which the node device 10b is affiliated. Therefore, the routing table 95 records the path information up to the node device 10 affiliated with the same cluster as the node device 10b. That is, the node device 10 records in the routing table 95 the path to the node device 10 affiliated with the local cluster. Therefore, in the node device 10 according to the present embodiment, the routing table 95 is smaller than the table when each node device records the paths to all node devices in the ad hoc network.

<Determining a Sub-Gateway>

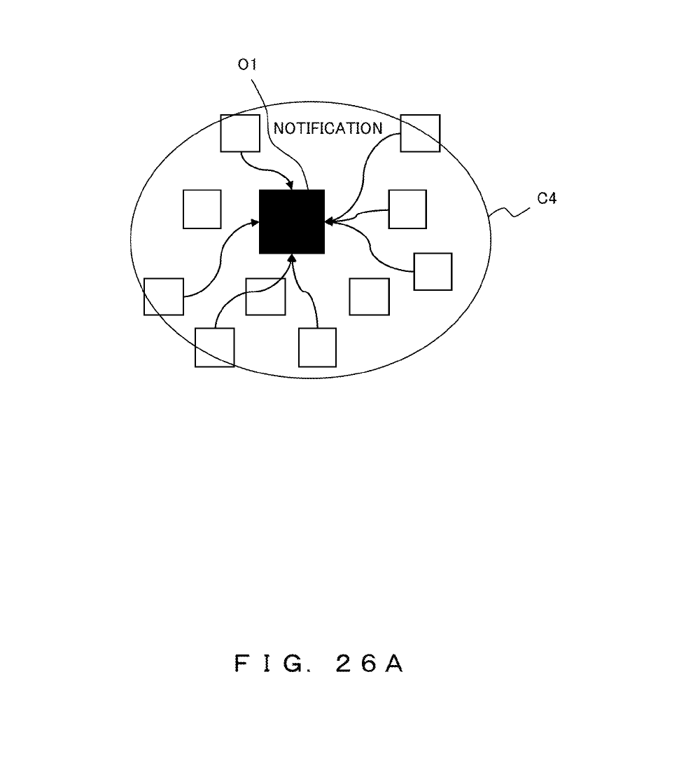

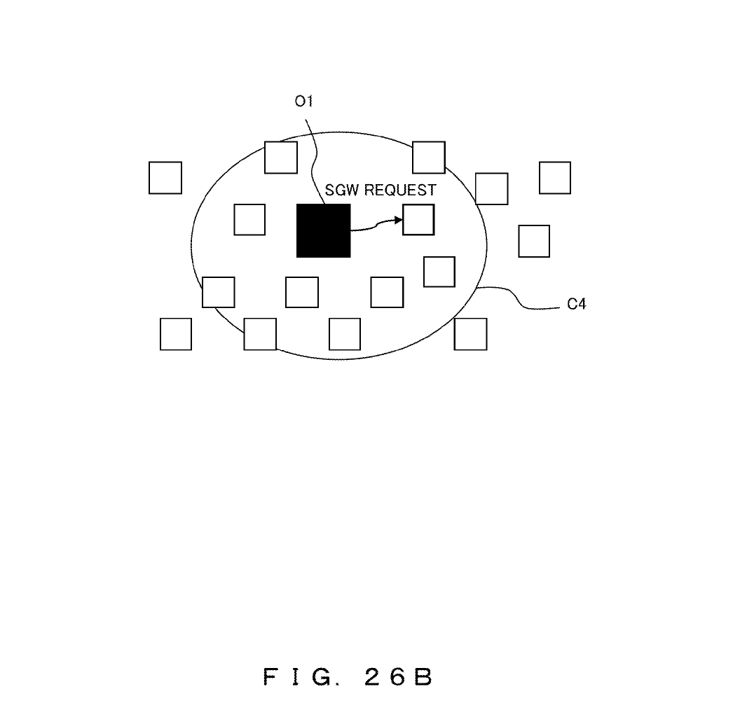

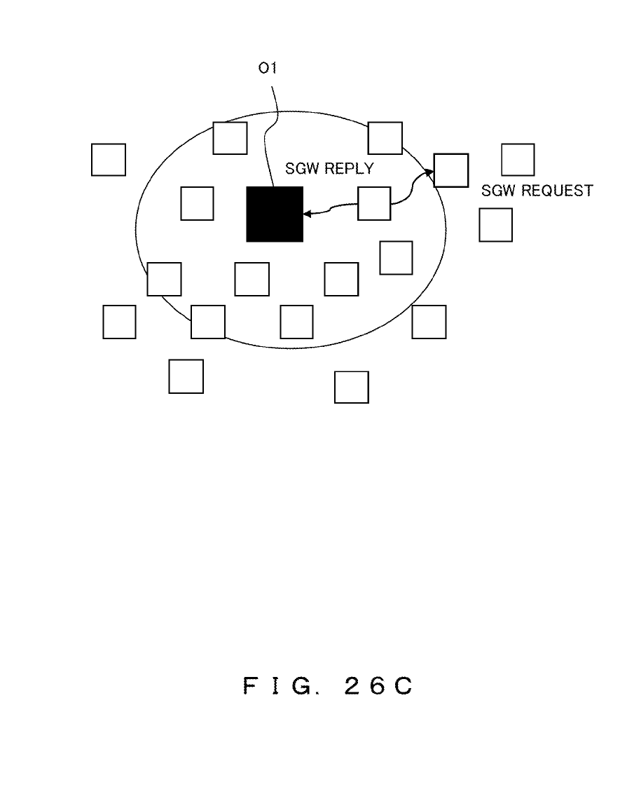

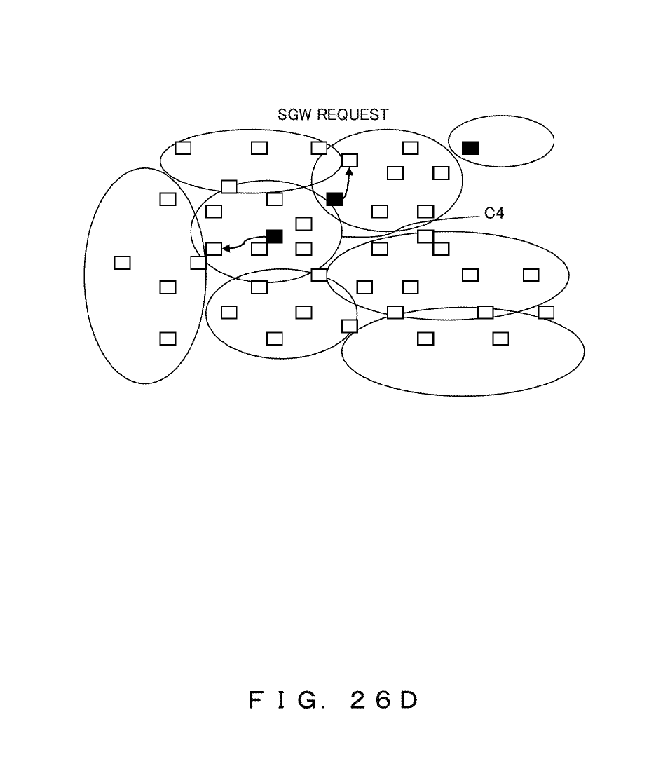

FIGS. 26A through 26D are examples of a method of determining a sub-gateway. First, the node device 10 recognizes the cluster adjacent to the cluster with which the device is affiliated (local cluster), and notifies the originating node device O1 of the cluster ID of the adjacent cluster as illustrated in FIG. 26A. The originating node device O1 selects a sub-gateway from among the node devices 10 which have reported the cluster IDs of the adjacent clusters. Furthermore, the originating node device O1 transmits a message (SGW request) to request to the selected node device 10 to operate as a sub-gateway as illustrated in FIG. 26B. Next, as illustrated in FIG. 26C, upon receipt of the SGW request, the node device 10 transmits an SGW reply message to the originating node device O1, and starts operating as a sub-gateway. Furthermore, upon receipt of the SGW request, the node device 10 transmits an SGW request to the node device 10 which is in the adjacent cluster, may receive a Hello packet, and operates as a sub-gateway. Furthermore, as illustrated in FIG. 26D, a sub-gateway is determined in the adjacent cluster.

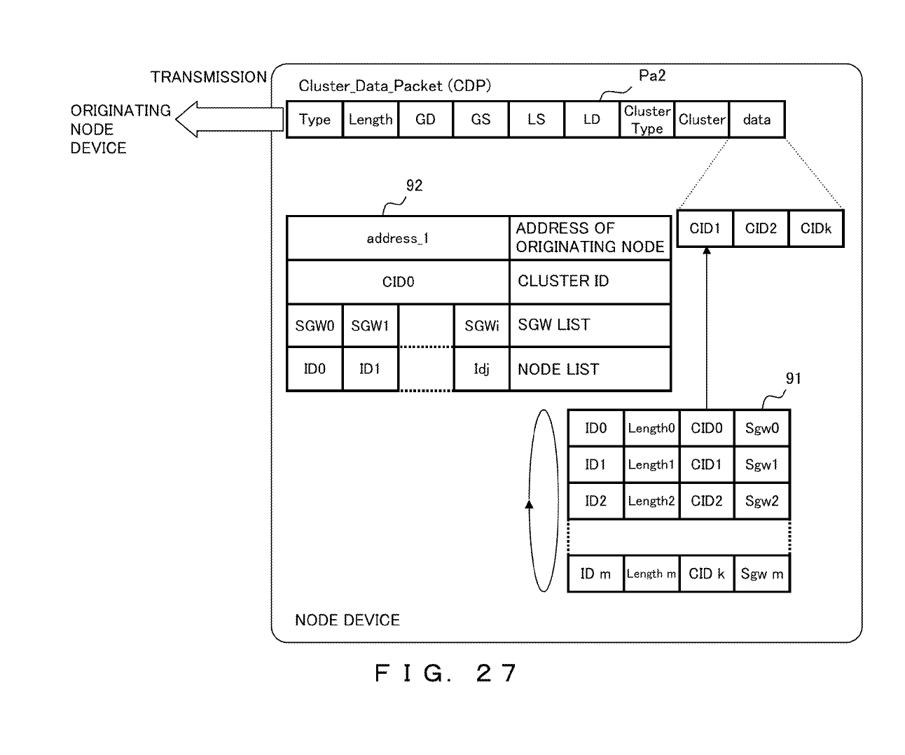

The method illustrated in FIG. 26 is described in detail with reference to FIGS. 27 through 33.

FIG. 27 is an explanatory view of an example of a method of recognizing the ID of a cluster adjacent to the local cluster. The node device 10 updates the link table 91 by communicating a Hello packet as described above. The link table 91 records the cluster ID of the cluster with which the adjacent node is affiliated. Then, the adjacent cluster notification unit 61 compares the value recorded in the column of the cluster ID of the link table 91 with the cluster ID of the local cluster. When the adjacent cluster notification unit 61 detects the ID of the cluster different from the cluster ID of the local cluster, the adjacent cluster notification unit 61 recognizes that a Hello packet is received from the node device 10 affiliated with the cluster adjacent to the local cluster. When the link table 91 and the cluster table 92 illustrated in FIG. 27 are held, it is recognized that the cluster with which the node device 10 is affiliated are adjacent to the cluster specified by the CID1, CID2, and CIDk. Then, the adjacent cluster notification unit 61 includes the detected cluster ID as indicated by the Pa2 illustrated in FIG. 27 in the data field of the cluster data packet to be transmitted to the originating node device O1. Furthermore, the adjacent cluster notification unit 61 sets the value of the cluster type field to “5” (NEI CLUSTER in FIG. 14). The adjacent cluster notification unit 61 transmits the generated packet to the originating node device.

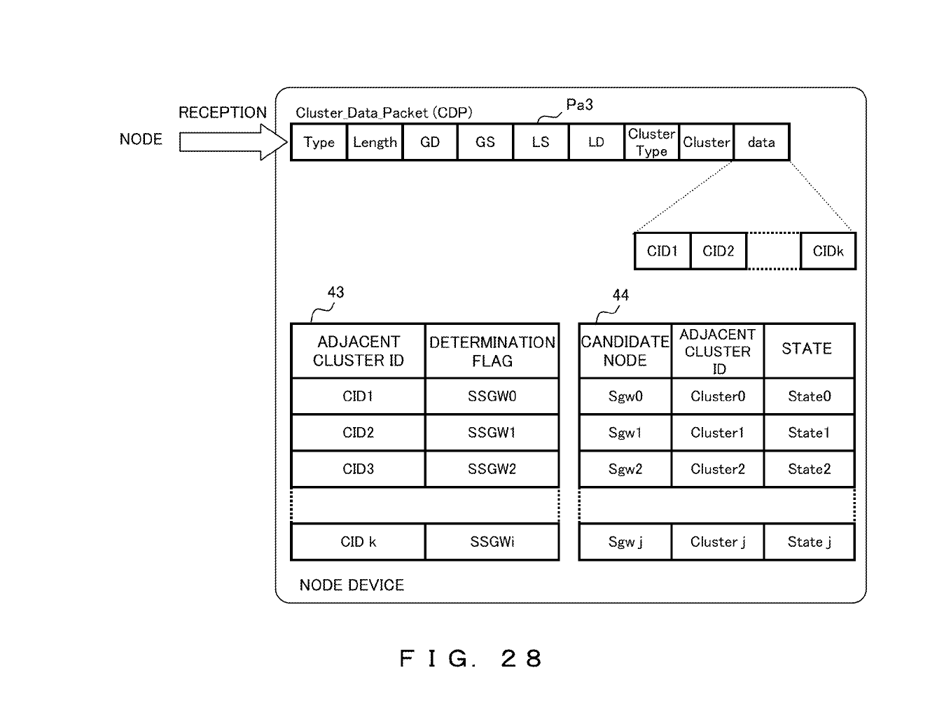

FIG. 28 is an example of an operation of an originating node device performed when a notification of an adjacent cluster is received. The candidate table generation unit 62 of the originating node device generates the adjacent cluster table 43 and the gateway candidate table 44 based on the received cluster data packet (Pa3 in FIG. 28). The adjacent cluster table 43 is used to recognize the adjacent cluster for which the sub-gateway determination unit 63 sets a sub-gateway. On the other hand, the gateway candidate table 44 is used to recognize the node device 10 for which the sub-gateway determination unit 63 may specify as a sub-gateway.

The adjacent cluster table 43 associates the ID of an adjacent cluster with a determination flag indicating the setting state of a sub-gateway used with the adjacent cluster as illustrated in FIG. 28. When the determination flag is set to “0”, it indicates that the sub-gateway used when communications are performed with the adjacent cluster has not been determined. On the other hand, when the sub-gateway is determined, the determination flag is set to “1”. That is, the sub-gateway determination unit 63 recognizes the cluster recorded in the entry having the value of “0” of the determination flag as a target for which a sub-gateway is determined. The candidate table generation unit 62 compares the cluster ID included in the data field of the received cluster data packet with the value recorded in the column of the adjacent cluster ID of the adjacent cluster table 43. When the cluster ID not included in the adjacent cluster table 43 is reported by the cluster data packet, the candidate table generation unit 62 generates a new entry in the adjacent cluster table 43, and records the adjacent cluster ID. In this case, the determination flag is set to O.

In the gateway candidate table 44, as illustrated in FIG. 28, the node device 10 as a candidate for a sub-gateway (candidate node), the ID of the cluster adjacent to the candidate node, and a state flag are associated with one another. The state flag=0 indicates that the candidate node does not operate as a sub-gateway. On the other hand, the state flag=1 indicates that the candidate node has been selected as a sub-gateway. The candidate table generation unit 62 retrieves a combination of a GS in the cluster data packet for notification of an adjacent cluster (Pa3 in FIG. 28) and the cluster ID reported by a data field from the gateway candidate table 44. When there is no combination of the GS and the cluster ID, the candidate table generation unit 62 generates an entry in the gateway candidate table 44, and records the combination of the GS and the cluster ID. In this case, the GS is recorded in the column of the candidate node. In a newly generated entry, the value of the state flag is set to 0.

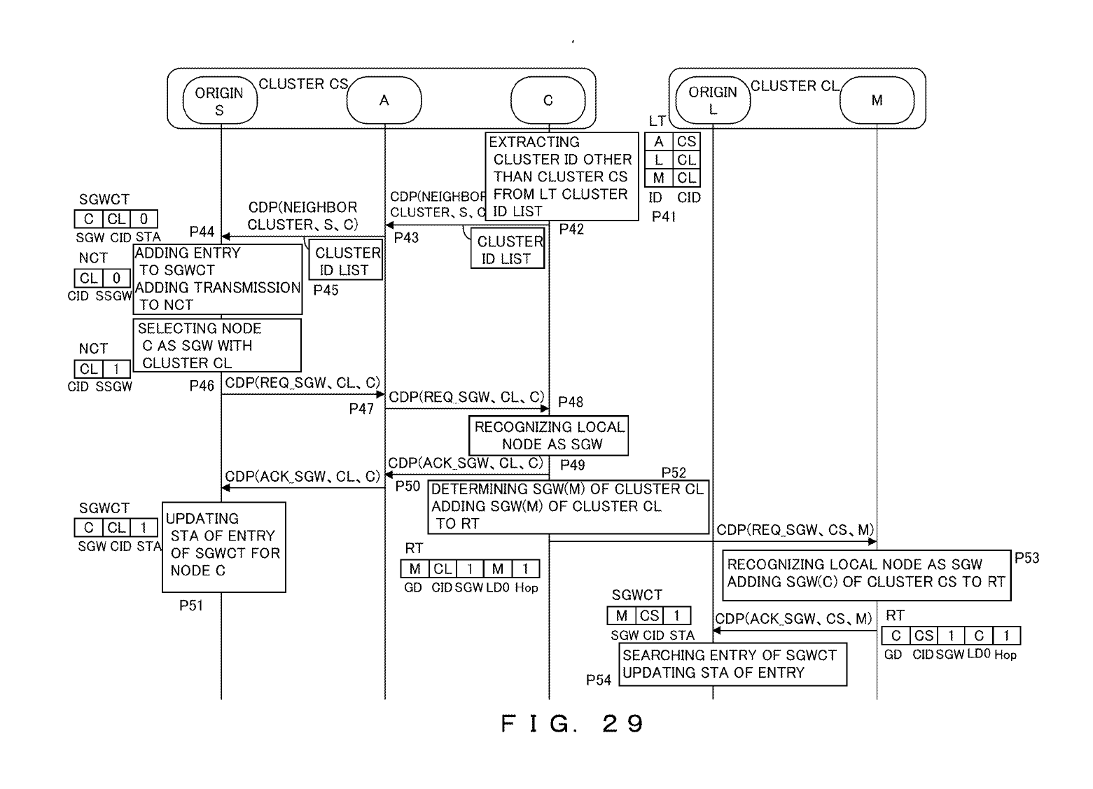

FIG. 29 is a sequential view for explanation of an example of an operation performed when a sub-gateway is determined. In the example in FIG. 29, described is setting a sub-gateway to be used between the cluster CS and the cluster CL. The node S is an originating node device of the cluster CS, and the node L is an originating node device of the cluster CL. The nodes A and C are affiliated with the cluster CS, and the node M is affiliated with the cluster CL. The following procedure is an example only, and a change may be made so that the processes in and after the procedure P52 are performed before the procedures P49 through P51.

The procedure P41 is described below. The adjacent cluster notification unit 61 of the node C compares the cluster ID recorded in the link table (LT) 91 with the cluster ID (CS) of the cluster with which the node C is affiliated, and then detects an adjacent cluster. In this example, it is assumed that the A, L, and M are recorded in the link table 91 of the node C. Since the local cluster of the nodes L and M is the cluster CL, the adjacent cluster notification unit 61 of the node C is recognized as adjacent to the cluster CL.

The procedure P42 is described below. The node C generates a cluster data packet including the list of an adjacent cluster (cluster ID list) in the data field. In FIG. 29, the cluster data packet which reports the adjacent cluster is expresses as (NEIGHBOR_CLUSTOR, S, C) by associating the destination originating node device and the source node device 10. NEIGHBOR_CLUSTOR indicates a cluster data packet reporting an adjacent cluster. After the description of the type of the cluster data packet, there are the descriptions that the originating node device is the node S and the source is the node C.

In the procedure P43, the cluster data packet transmitted from the node C in the procedure P42 is transmitted by the node A to the node S.

The procedure P44 is described below. The candidate table generation unit 62 of the node S updates the adjacent cluster table (NCT) 43 and the gateway candidate table (SGWCT) 44 using a received packet. The method of updating the adjacent cluster table 43 and the gateway candidate table 44 is described above with reference to FIG. 28. In the example in FIG. 29, the ID of the cluster CL is registered in the adjacent cluster table 43. In the gateway candidate table 44, it is recorded that the node C is adjacent to the node device 10 included in the cluster CL.

The procedure P45 is described below. The sub-gateway determination unit 63 acquires the ID of the cluster whose determination flag is set to 0 from the adjacent cluster table 43. Next, the sub-gateway determination unit 63 retrieves the node device 10 whose state flag is set to 0 in the candidate nodes associated with the acquired cluster identifier by confirming the gateway candidate table 44. The sub-gateway determination unit 63 determines the node device 10 specified as a sub-gateway from among the retrieved node devices 10. For example, in the example illustrated in FIG. 29, the value of the determination flag associated with the ID of the cluster CL is O. Then, the sub-gateway determination unit 63 judges that no sub-gateway to be used in communications with the cluster CL has been determined, and retrieves the node device 10 having the state flag=0 in the candidate nodes registered in the gateway candidate table 44. The node C is adjacent to the node in the cluster CL, and has the value of 0 of the state flag. Then, the sub-gateway determination unit 63 of the node S determines the node C as a sub-gateway.

The procedure P46 is described below. The sub-gateway determination unit 63 transmits a cluster data packet (SGW request, REQ_SGW) which requests the node device 10 specified as a sub-gateway to operate as a sub-gateway. As illustrated in FIG. 14, when the SGW request is issued, the value of the cluster type field is set to “6”. In addition, the ID of the adjacent cluster is recorded in the cluster ID field. The sub-gateway determination unit 63 transmits the cluster data packet of the SGW request to the candidate node determined in the procedure P45. Furthermore, the sub-gateway determination unit 63 sets to “1” the determination flag associated with the adjacent cluster whose ID is recorded in the cluster ID field of the SGW request.

For example, the sub-gateway determination unit 63 of the node S generates a cluster data packet in which the ID of the cluster CL is set in the cluster ID field, and 6 is set in the cluster type field, and transmits the packet to the node C. In FIG. 29, the SGW request is associated with the adjacent cluster ID, and the adjacent node device 10 expressed as (REQ_SGW, CL, C). After transmitting the SGW request, the sub-gateway determination unit 63 sets to 1 the determination flag associated with the cluster CL in the adjacent cluster table 43.

In the procedure P47, the node A refers to the routing table 95, and transmits to the node C the SGW request received from the node S.

The procedure P48 is described below. Upon receipt of the SGW request, the node C recognizes that the node C is a sub-gateway, and starts the operation as a sub-gateway. For example, although the node C receives a Hello packet from the node device 10 affiliated with the cluster different from the local cluster of the node C, the node C updates the routing table 95 according to the Hello packet. In addition, the SGW flag is set to 1 in the Hello packet transmitted from the node C. The operation as a sub-gateway is described later in detail.

The procedure P49 is described below. The node C transmit the cluster data packet as an SGW reply (ACK SGW) to the node S. As illustrated in FIG. 14, in the case of the SGW reply, the value of the cluster type field is set to “7”. Furthermore, the ID of the adjacent cluster is recorded in the cluster ID field. In FIG. 29, the SGW reply is associated with the adjacent cluster ID and the source node device 10, and expressed as (REQ_ACK, CL, C).

In the procedure P50, the node A refers to the routing table 95, and transmits to the node S the SGW reply received from the node C.

The procedure P51 is described below. Upon receipt of the SGW reply, the originating node sets to 1 the state flag corresponding to the source node device of the SGW reply in the gateway candidate table 44. In this example, upon receipt of the SGW reply, the node S sets to 1 the state flag of the entry whose adjacent cluster for the node C is the CL.

The procedure P52 is described below. The node C set as a sub-gateway is the node device 10 in the cluster CL, and requests the node device 10 adjacent to the node C to operate as a sub-gateway. In this case, the sub-gateway determination unit 63 of the node C refers to the cluster table 92, and selects the node device included in the cluster CL so that the node device may be set as a sub-gateway. In this case, assume that the sub-gateway determination unit 63 has selected the node M. The sub-gateway determination unit 63 generates a SGW request and transmits the request to the node M. The generation of the SGW request is similar to the process in the procedure P42. Furthermore, the sub-gateway determination unit 63 adds the entry of the node M to the routing table (RT) 95. In this case, the node M as a sub-gateway is also registered.

The procedure P53 is described below. Upon receipt of the SGW request, the node M recognizes that an SGW request has been received from the node affiliated with the cluster (cluster CS) different from the local cluster (cluster CL) of the node M. Then, the node M starts operating as a sub-gateway. Furthermore, by transmitting the SGW reply to the originating node device of the affiliated node, the originating node device is reported that it is operating as a sub-gateway. In this example, the node M transmits the SGW reply to the node L. The method of generating an SGW reply is described above in the procedure P49. Furthermore, the sub-gateway determination unit 63 of the node M adds an entry of the node C to the routing table 95. In this case, the node C is also registered as a sub-gateway.

The procedure P54 is described below. The operation of the originating node is similar to the process of the procedure P51. That is, upon receipt of an SGW reply, the node L sets to 1 the state flag of the entry in which the adjacent cluster of the node M is the CL in the gateway candidate table 44.

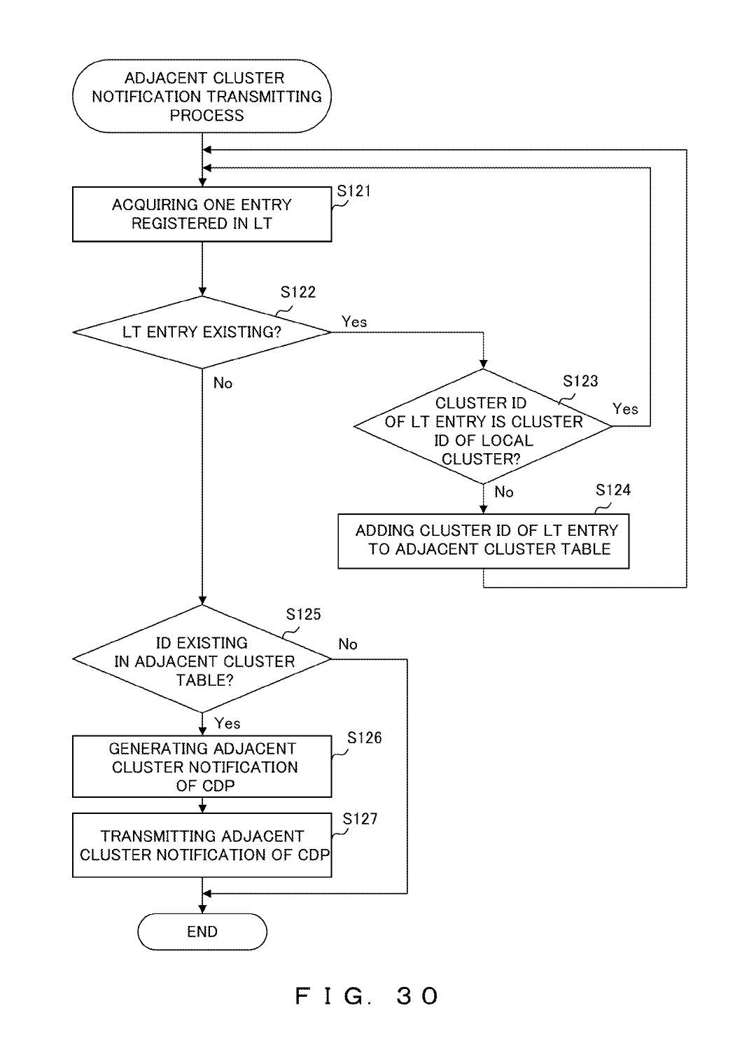

FIG. 30 is a flowchart for explanation of an example of the operation of the adjacent cluster notification unit 61. The adjacent cluster notification unit 61 acquires one unprocessed entry registered in the link table 91 (YES insteps S121 and S122). Next, the adjacent cluster notification unit 61 confirms whether or not the cluster ID included in the acquired entry is the cluster ID of the local cluster (step S123). When the cluster ID of the local cluster is included, the adjacent cluster notification unit 61 returns control to step S121, and starts processing another entry (YES in step S123). On the other hand, if the cluster ID of the acquired entry is different from the cluster ID of the adjacent cluster, the adjacent cluster notification unit 61 records the cluster ID included in the acquired entry in the adjacent cluster table 43, and control is returned to step S121 (step S124 after NO in step S123). When the process are completed on all entries in the link table 91, the adjacent cluster notification unit 61 confirms whether or not a cluster ID has been recorded in the adjacent cluster table 43 (step S125). If a cluster ID is recorded in the adjacent cluster table 43, the adjacent cluster notification unit 61 generates a cluster data packet for notification of an adjacent cluster, and transmits the packet to the originating node device of a local cluster (steps S126 and S127 after YES in step S125). On the other hand, when no cluster ID is recorded in the adjacent cluster table 43, the adjacent cluster notification unit 61 terminates the process (NO in step S125).

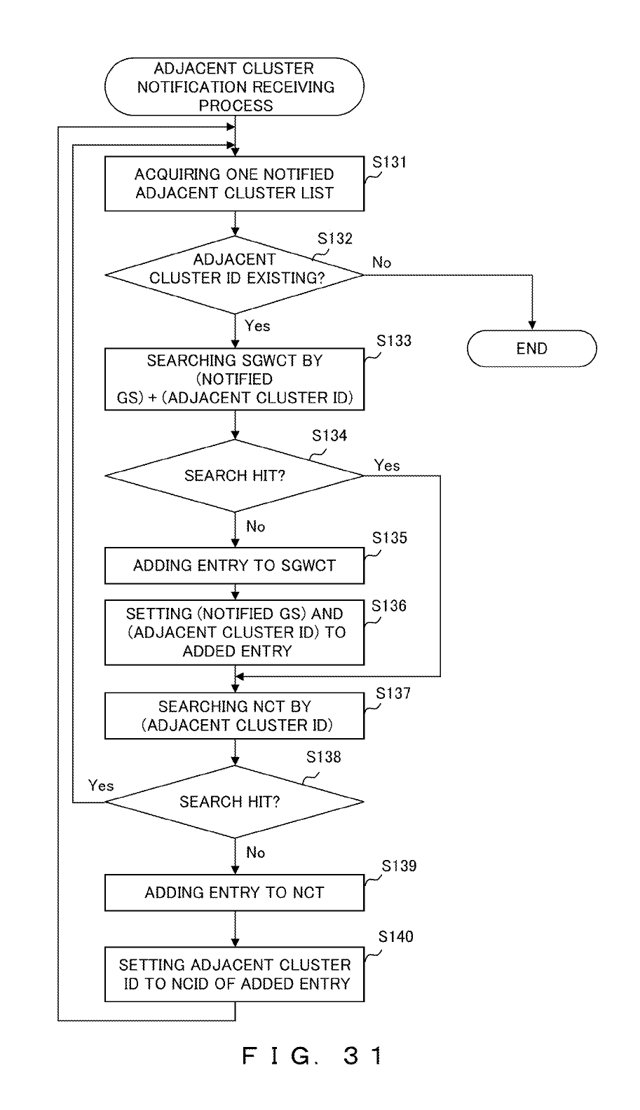

FIG. 31 is a flowchart for explanation of an example of an operation of the candidate table generation unit 62 when an adjacent cluster is notified. FIG. 31 is an example of an operation performed in the procedure P44 explained with reference to FIG. 29. Upon receipt of a notification of an adjacent cluster, the candidate table generation unit 62 confirms whether or not a cluster ID is included in the cluster data packet (steps S131 and S132). If an unprocessed cluster list is not included in the cluster data packet, the candidate table generation unit 62 terminates the process (NO in step S132). On the other hand, when a cluster ID is included, the candidate table generation unit 62 searches the gateway candidate table 44 by the combination of the source address (GS) of the cluster data packet and the cluster ID (adjacent cluster) in the received packet (step S133). If the combination of the GS and the adjacent cluster has not been recorded in the gateway candidate table 44, the candidate table generation unit 62 adds an entry of the combination of the GS and the adjacent cluster to the gateway candidate table (steps S135 and S136 after NO in step S134). If the combination of the GS and the adjacent cluster has been recorded in the gateway candidate table 44, steps S135 and S136 are not performed (YES in step S134). Next, the candidate table generation unit 62 searches the adjacent cluster table 43 using the adjacent cluster ID as a key (step S137). If the adjacent cluster ID has been recorded in the adjacent cluster table 43, the candidate table generation unit 62 repeats the processes in and after step S131 (YES in step S138). On the other hand, if no adjacent cluster ID has been recorded in the adjacent cluster table 43, the candidate table generation unit 62 adds an entry having a record of an adjacent cluster ID to the adjacent cluster table 43 (steps S139 and S140 after NO in step S138).

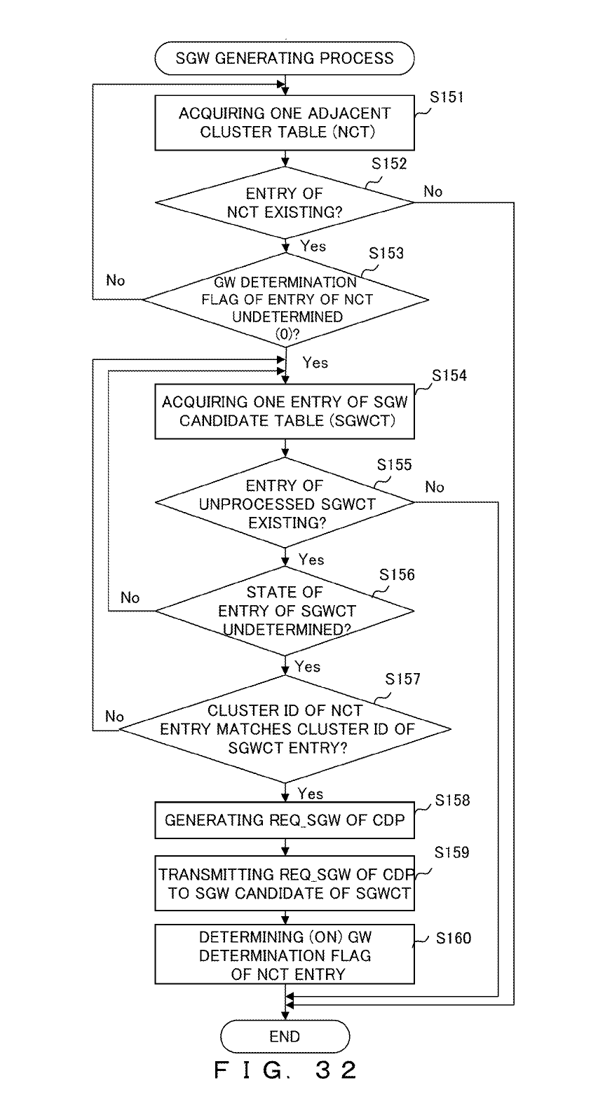

FIG. 32 is a flowchart for explanation of an example of an operation of an originating node device when a sub-gateway is generated. The sub-gateway determination unit 63 in the originating node device reads an unprocessed entry (YES in step S152 after step S151). If no unprocessed entry is left in the adjacent cluster table 43, the sub-gateway determination unit 63 terminates the process (NO in step S152). When an unprocessed entry is read, the sub-gateway determination unit 63 confirms the value of the determination flag (step S153). If the value of the determination flag is 1, and the sub-gateway has already been determined, the sub-gateway determination unit 63 returns control to step S151 (NO in step S153).

On the other hand, if the value of the determination flag is 0, and a sub-gateway has not been determined, the sub-gateway determination unit 63 acquires an unprocessed entry from the gateway candidate table 44 (step S154, and YES in step S155). If an unprocessed entry is not acquired from the gateway candidate table 44, the sub-gateway determination unit 63 terminates the process (NO in step S155). Next, the sub-gateway determination unit 63 confirms whether or not the state flag of the acquired entry indicates “not determined” (state flag=0) (YES in step S155, and step S156). If the state flag of the acquired entry is not “not determined” (state flag=1), then the processes in and after step S154 are repeated (NO in step S156). On the other hand, when the state flag of the acquired entry indicates “not determined”, the sub-gateway determination unit 63 confirms whether or not the cluster ID of the adjacent cluster table 43 matches the cluster ID of the gateway candidate table 44 (step S157). If they do not match, the processes in and after step S154 are repeated (NO in step S157).

When the cluster ID of the adjacent cluster table 43 matches the cluster ID of the gateway candidate table 44, the sub-gateway determination unit 63 generates an SGW request (YES in step S157, and step S158). Furthermore, the sub-gateway determination unit 63 transmits the SGW request to the node recorded in the entry of the gateway candidate table 44 read in step S155 (step S159). Furthermore, the sub-gateway determination unit 63 set the determination flag as “determined” (determination flag=1) for the entry of the adjacent cluster table 43 read in step S151 (step S160). In this flowchart, the originating node performs only once the process of setting a sub-gateway for the adjacent cluster whose sub-gateway has not been determined. To perform the process on a plurality of adjacent clusters whose sub-gateway has not been yet, the processes in steps S151 through S160 may be simultaneously performed in parallel.

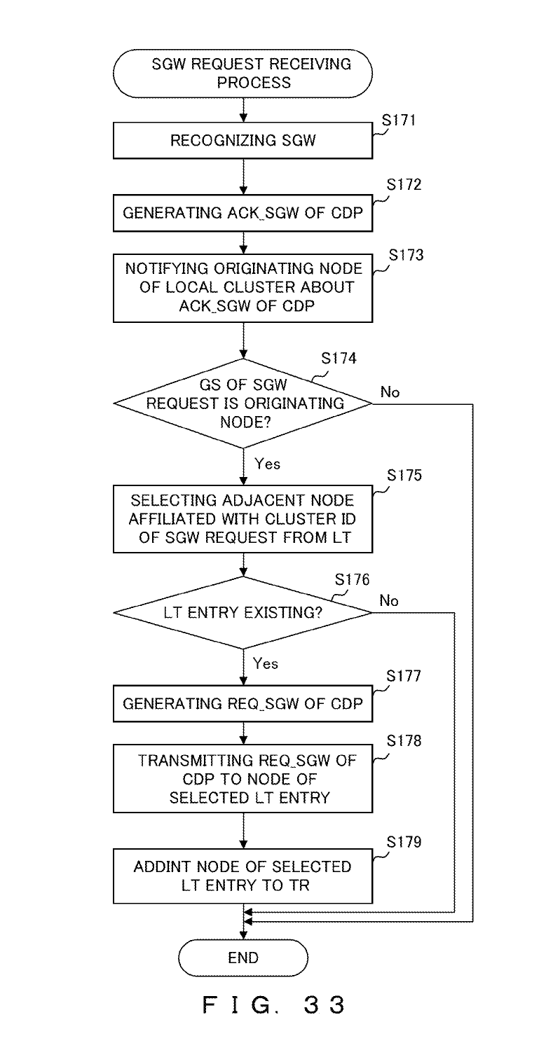

FIG. 33 is a flowchart for explanation of an operation of a node specified by a sub-gateway. Upon receipt of an SGW request, a node recognizes that it is set as a sub-gateway, and generates an SGW reply (steps S171 and S172). The sub-gateway determination unit 63 transmits the generated SGW reply to the originating node device of a local cluster (step S173). Furthermore, the sub-gateway determination unit 63 confirms whether or not the source (GS) of the SGW request is an originating node device (step S174). If the source of the SGW request is not an originating node device, the process terminates (NO in step S174).

On the other hand, if the source of the SGW request is an originating node device, the sub-gateway determination unit 63 selects the adjacent node affiliated with the cluster identified by the cluster ID of the SGW request from the link table 91 (step S175 after YES in step S174). If there is a corresponding entry in the link table 91, the sub-gateway determination unit 63 generates an SGW request and transmits it to the selected node (steps S177 and S178 after YES in step S176). Furthermore, the sub-gateway determination unit 63 registers the entry of the selected link table 91 in the routing table 95 (step S179). On the other hand, in step S176, if the adjacent node affiliated with the cluster identified by the cluster ID of the SGW request is not included in the link table 91, the sub-gateway determination unit 63 terminates the process (NO in step S176).

If the sub-gateway is determined, the default GW determination unit 41 selects the sub-gateway used when a packet is transmitted to the node device 10 not affiliated with any local cluster. In the following explanation, the sub-gateway used when a packet is transmitted to the node device 10 not affiliated with any local cluster is described as a “default gateway”.

The node device 10 in the cluster may define a sub-gateway having the smallest hop count as a default gateway. The method of using a hop count is an example of a method of determining a default gateway, and a method of determining a default gateway may be arbitrarily changed depending on the implementation. For example, a default gateway may be determined using a communication quality (attainability, congestion, etc.).

<Process of Hello Packet after Determining Sub-Gateway>

The operation performed when a Hello packet is processed after a sub-gateway is determined is explained below with reference to FIG. 21. The process when a sub-gateway receives a Hello packet from a node affiliated with a local cluster is performed in steps S61 through S72. The process of updating the cluster table 92 in step S66 is described below with reference to FIG. 23. Upon receipt of a Hello packet, a node confirms using an SGW flag of the Hello packet as to whether or not the source (LS) of the Hello packet is a sub-gateway (step S91). If the source is a sub-gateway, the node which has received the Hello packet confirms whether or not the source of the Hello packet has been received in the sub-gateway list of the cluster table 92 (steps S92 and S93). If a sub-gateway has been registered in the cluster table 92, the update process of the cluster table 92 is terminated (YES in step S93). On the other hand, if a sub-gateway has not been registered in the cluster table 92, the node which has received the Hello packet records the source of the Hello packet in the sub-gateway list of the cluster table 92 (step S94 after NO in step S93). The process performed when the source of a Hello packet is not a sub-gateway is described above.

The update of the cluster table 92 performed in step S72 is described below with reference to FIG. 25. Upon receipt of a Hello packet, a node confirms about the list of the path information included in the data part of the Hello packet whether or not the GD is a sub-gateway (step S111). If the GD is a sub-gateway, then the node which has received the Hello packet confirms whether or not the GD is recorded in the sub-gateway list of the cluster table 92 (steps S112 and S113). If the sub-gateway has been recorded in the cluster table 92, the update process of the cluster table 92 is terminated (YES in step S113). On the other hand, unless the sub-gateway has not been registered in the cluster table 92, the node which has received the Hello packet records the GD in the sub-gateway list of the cluster table 92 (step S114 after NO in step S113). The process performed when the GD of the path reported by the Hello packet is not a sub-gateway is described above.

The process performed when a Hello packet is received from a cluster different from a local cluster (NO in step S64 in FIG. 21) is described below with reference to FIG. 21. Upon receipt of a Hello packet, the node device 10 confirms whether or not it is a sub-gateway (step S73). If the node device 10 which has received the Hello packet is a sub-gateway, the path management unit 21 updates the routing table 95 and the cluster table 92 (steps S74 and S75 after YES in step S73). The process in step S74 is similar to the process described above with reference to FIG. 22. The process in step S75 is similar to the process described above with reference to FIG. 23. On the other hand, if the node device 10 which has received the Hello packet is not a sub-gateway, the node device 10 terminates the process (NO in step S73).

<Communication of Data Packet in Cluster>

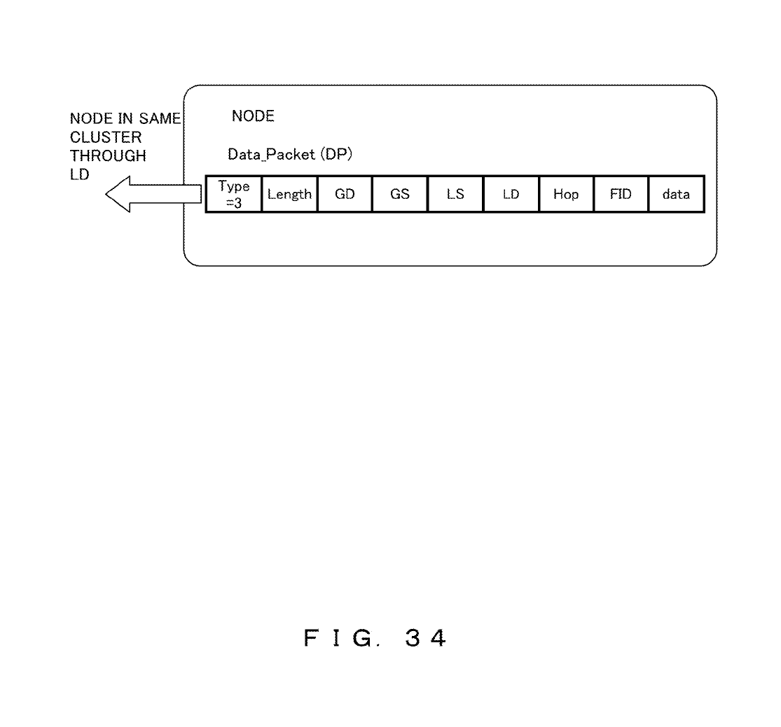

FIG. 34 is an example of a format of a data packet. The data packet process unit 81 generates a data packet. In this case, the value of the Type field of the header of the data packet is set to “3” as illustrated in FIG. 4. The value of the Length field indicates the length of the data included in the data packet. The data packet process unit 81 sets the destination address of the data packet as the GD. Furthermore, the data packet process unit 81 searches the column of the GD of the routing table 95 using the destination address, and sets the node registered as the LD in the hit entry as the LD. In addition, the data packet process unit 81 sets the GS and the LS as the address of the source node. The hop count is used to count the hop count from the source node, and is set to 0 n the source node. In the FID field, the value input from the FID generation unit 13 is recorded. The data field includes transmission data. By combining the GS and the FID, the uniqueness of the packet is expressed in the network.

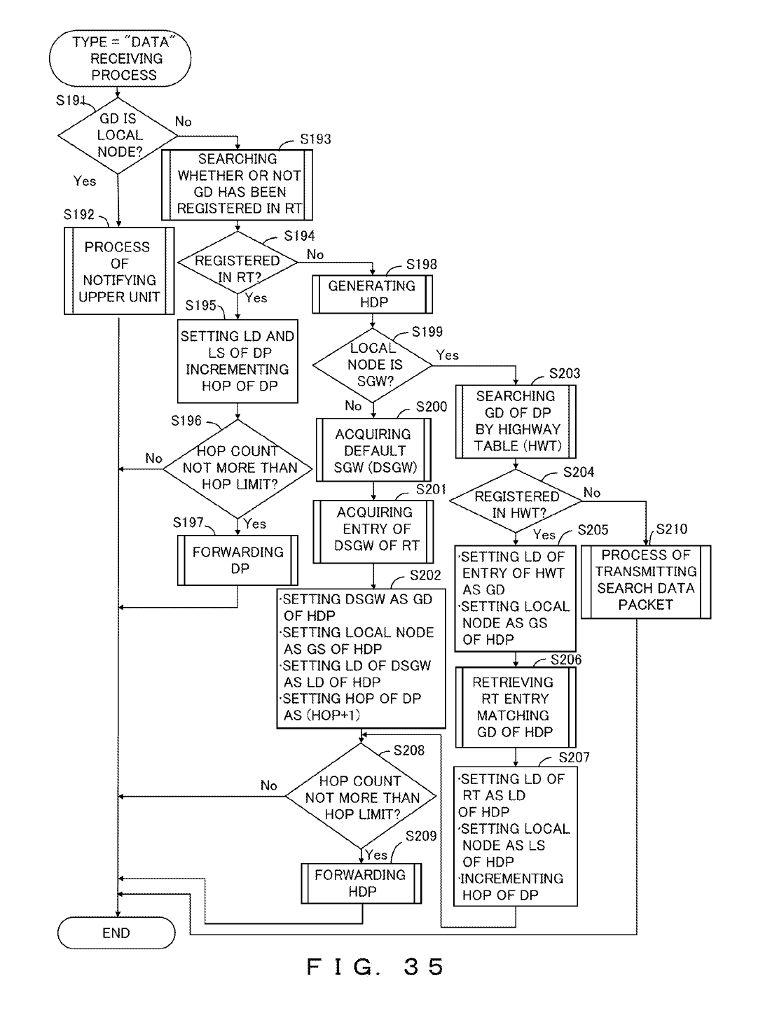

FIG. 35 is a flowchart for explanation of an example of an operation performed when a data packet is received. The data packet process unit 81 confirms whether or not the GD of the data packet received through the packet branch process unit 12 matches the address assigned to the node device 10 which has received the packet (step S191). If the GD of the data packet matches the address assigned to the node device 10, the data packet process unit 81 judges that the data packet is to be processed by the upper process unit 14, and notifies the upper process unit 14 of the judgment (step S192 after YES in step S191). Furthermore, the data packet process unit 81 may appropriately output the data packet to the upper process unit 14.

On the other hand, if the GD of the data packet does not match the address assigned to the node device 10, then the data packet process unit 81 determines that the received packet is to be forwarded to another node (NO in step S191). The data packet process unit 81 searches the column of the GD of the routing table 95, using the address recorded in the GD of the data packet as a key, and confirms whether or not there is an hit entry (steps S193 and S194). If the node set as the generated is affiliated with the local cluster, then there is an entry hit in the routing table 95 (YES in step S194). The data packet process unit 81 changes the LD of the data packet to the address of the node recorded as the LD in the hit entry, and changes the LS to the address of the node device 10 which is processing the data packet. Furthermore, the value of the hop count is incremented by 2 (step S195). The data packet process unit 81 compares the value of the hop count with the Hop limit value stored in advance (step S196). If the value of the hop count is not more than the Hop limit value, the data packet process unit 81 forwards the data packet through the transmission unit 16 (step S197 after YES in step S196). On the other hand, if the value of the hop count exceeds the Hop limit value, the data packet process unit 81 discards the data packet and terminates the process (NO in step S196). If it is judged NO in step S194, the node set as the generated is not affiliated with the local cluster. The process performed in this case is described later.

<Method of Communicating with Node Device not Included in Local Cluster>

The node device 10 which is not a sub-gateway does not record the path to the node device 10 which is not affiliated with the local cluster in the routing table 95. Then, when a packet is transmitted to the node device 10 which is not included in the local cluster, the node device 10 transmits a highway data packet to the default gateway of the node device 10.

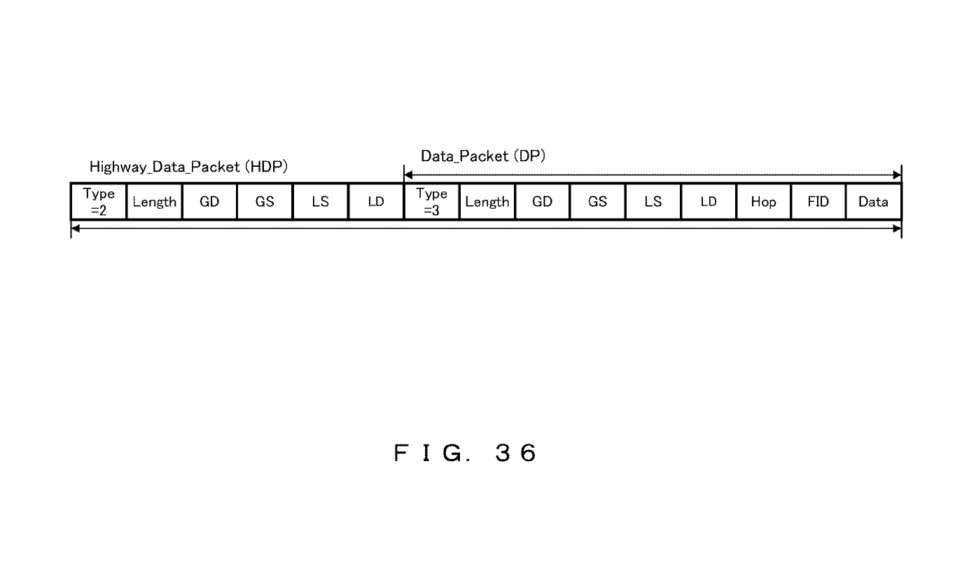

FIG. 36 is an example of a format of a highway data packet. The highway data packet is generated by the highway data packet process unit 82. The highway data packet further includes a header at the head of a data packet. For easier discrimination, the header added to the head of a highway data packet is hereafter referred to as an “outer header”, and the header included in the data packet in the highway data packet is hereafter referred to as an “inner header”. The format of the outer header is the same as that of the inner header.

In the Type field of the outer header, a value indicating the highway data packet is set. In the example in FIG. 36, the Type field at the head of the highway data packet is set to 2. The GD of the outer header records the address of the destination node of the highway data packet. For example, the source node has the destination node of the highway data packet as a default gateway of the source node.

The GS, LS, and LD of the outer header are similarly set as in the case of the data packet. On the other hand, as for the inner header, the LS and LD are not to be set. The GD of the inner header is set as the address of the destination node of the data packet, and the GS is set as the address of the source node of the data packet.

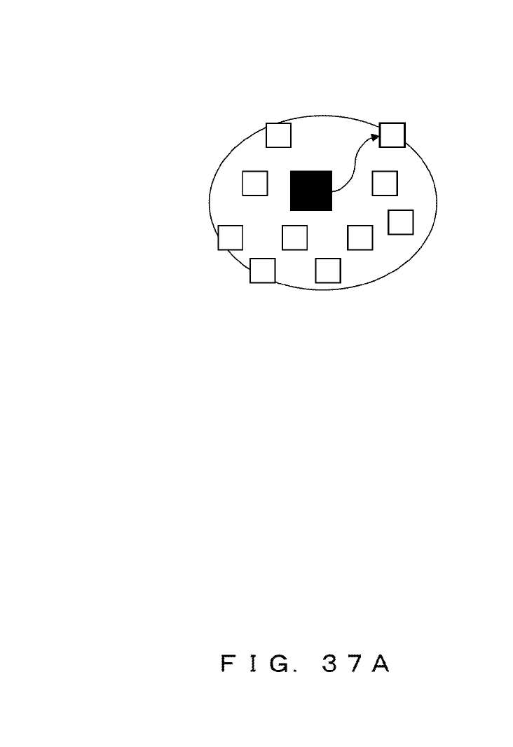

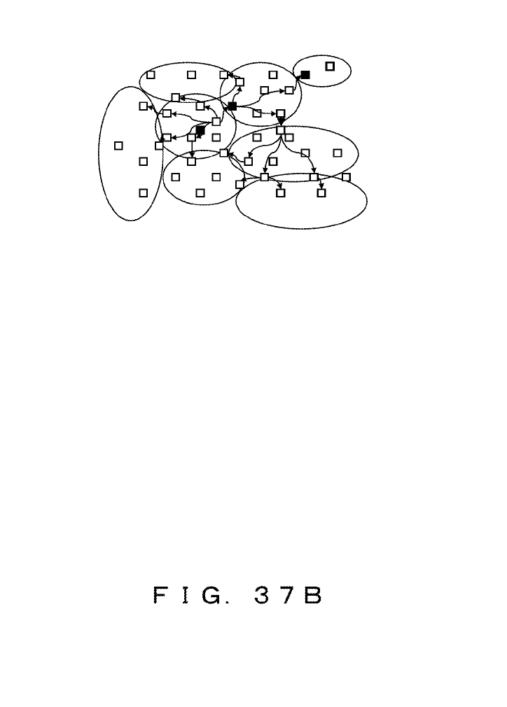

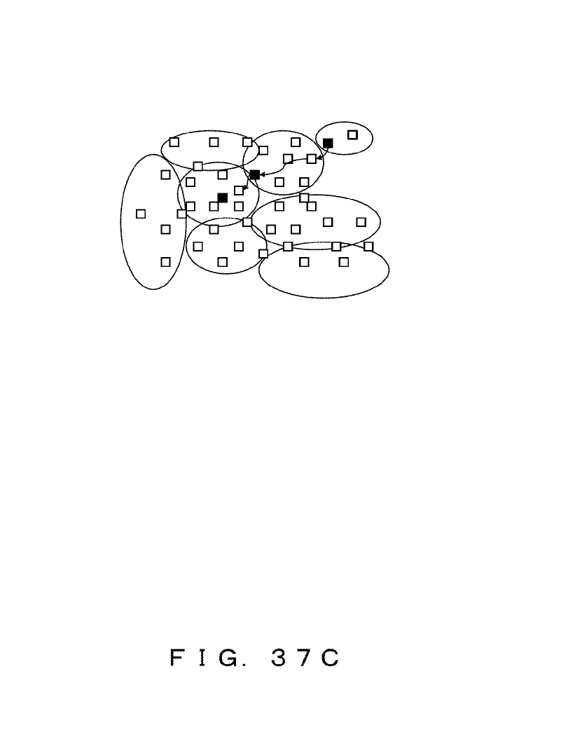

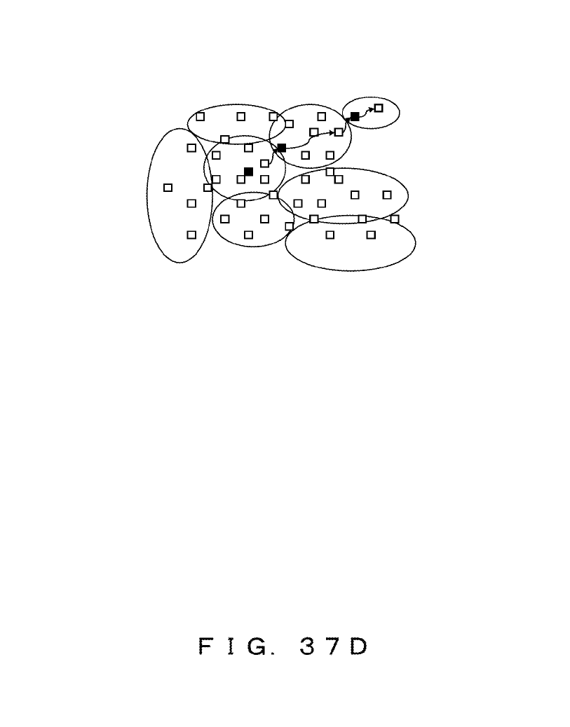

FIGS. 37A through 37D are examples of a communication method with a node device not included in a local cluster. As illustrated in FIG. 37A, the source node first generates a highway data packet, and transmits the highway data packet to the default gateway of the source node. Then, upon receipt of the highway data packet, the sub-gateway acquires the GD of the inner header of the highway data packet, and searches for a cluster with which the acquired GD is affiliated. A search data packet is used in searching for a cluster.

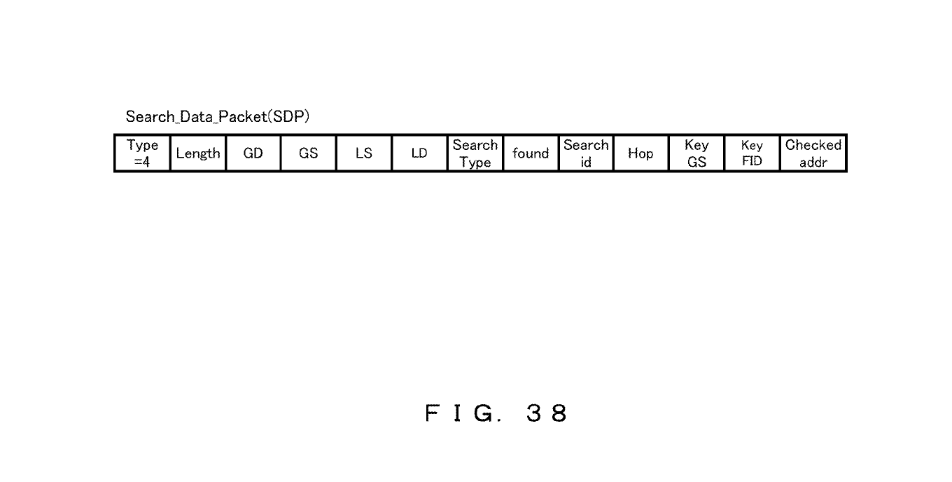

FIG. 38 is an example of a format of a search data packet. A search data packet is generated by the search execution unit 72. The payload of the search data packet includes a SearchType field, a found flag, a Search ID field, a hop count, a KeyGS field, a KeyFID field, and a Checkedaddr field. The Search ID field is used to discriminate between a search request and a notification of a result of a search of a search data packet. In the explanation below, the value of the SearchType field is set to 0 in the search data packet which requests a search. In the search data packet for notification of a result of search, the value of the SearchType field is set to 1. The Search ID field records the address of the node to be searched for. The found flag indicates whether or not a node to be searched for has been detected. found flag=0 indicates “not detected yet”, and found flag=1 indicates “successful detection”, the hop count indicates the hop count from the source of the search data packet to the detected node. The KeyGS field records the GS set in the inner header (header of a data packet) in the highway data packet, and the KeyFID field records the FID of the inner header. The Checkedaddr field records the information about the cluster to be searched.

The Type field of a search data packet is set to a value indicating the search data packet. For example, in the example in FIG. 4B, the Type field is set to “4”. The GD of the search data packet is the address of the sub-gateway in the cluster to be searched. The LS is the address of the node which transmits a search data packet. The GS is the source address of the search data packet, the LD is the destination address to the GD. The data packet process unit 81 acquires the LD by referring to the routing table 95.

The search execution unit 72 in the sub-gateway which searched a cluster transmits a search data packet to each cluster adjacent to the local cluster of the sub-gateway.

FIG. 37B is an example of a case in which the search data packet is transmitted. Each of the sub-gateways which have received a search data packet confirms whether or not the node device 10 to be searched for is affiliated with the local cluster. When the node device 10 to be searched for is not detected, the sub-gateway newly generates a search data packet. and transmits the packet to the cluster adjacent to the local cluster. When the node device 10 to be searched for is detected, the sub-gateway notifies the node device 10 which has issued an inquiry to the sub-gateway or a result of the search. FIG. 37C illustrates the notification of the result of the search. Upon receipt of the highway data packet, the sub-gateway removes the outer header of the highway data packet, and transmits the data packet to the destination of the data packet. FIG. 37D is an example of the transmission of the data packet.

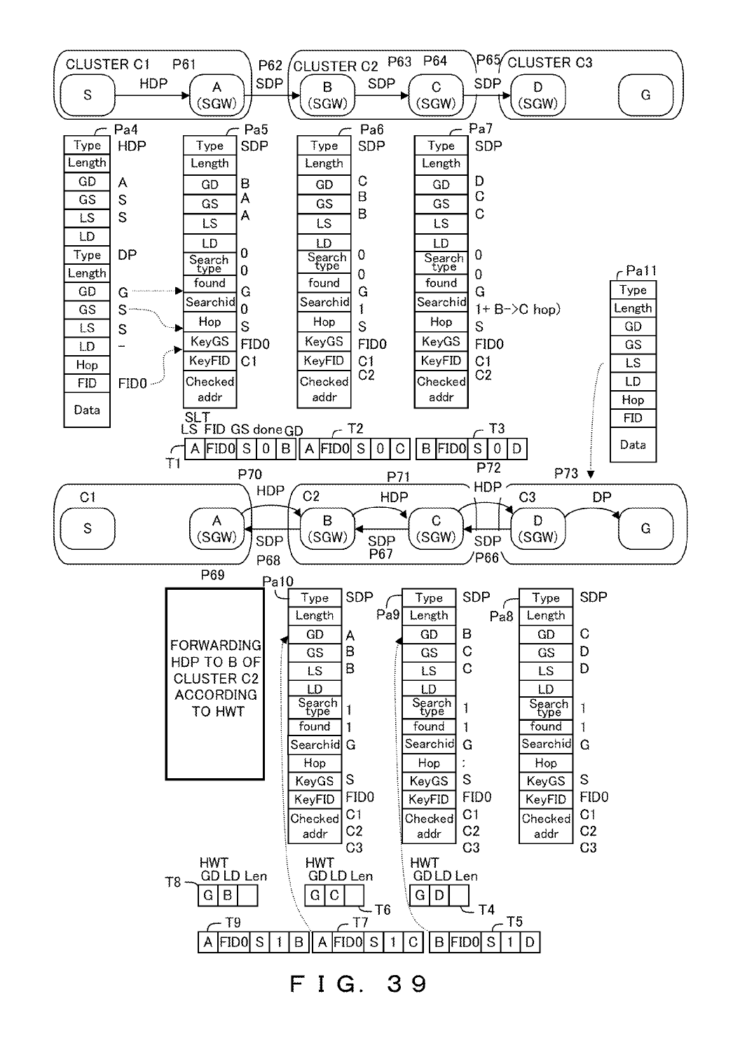

Next, the operation of transmitting a data packet is described in detail with reference to FIG. 39.

FIG. 39 is an example of a method of retrieving a destination of a data packet and an example of transmitting a data packet. In the example in FIG. 39, it is assumed that the node S affiliated with the cluster C1 transmits a data packet to the node G affiliated with the cluster C3. In this example, it is assumed that the node S and the node A are affiliated with the cluster C1, the node B and the node C are affiliated with the cluster C2, and the node D and the node G are affiliated with the cluster C3. In addition, the node A is a default gateway of the node S. Furthermore, it is assumed that the cluster C1 is adjacent to the cluster C2, but is not adjacent to the cluster C3, and the cluster C2 is adjacent to the cluster C1 and the cluster C3.

The procedure P61 is described below. The data packet process unit 81 of the node S generates a data packet addressed to the node G. The GD of the data packet is set as node G, and the GS and the LS are set as the node S. However, when the data packet process unit 81 recognizes that the node G is not recorded in the routing table 95, it does not set the LD, but outputs the generated packet to the highway data packet process unit 82.

The highway data packet process unit 82 adds an outer header to the input data packet. The highway data packet process unit 82 sets the GD of the outer header as the node A which is a default gateway of the node S. The GS and the LS of the outer header are set as node S. The highway data packet process unit 82 refers to the routing table 95, acquires the LD for specification in transmitting a packet to the node A, and sets the acquired value as the LD of the outer header. The generated packet is indicated by Pa4. The highway data packet process unit 82 transmits the highway data packet toward the node A.

The procedure P62 is described below. Upon receipt of the highway data packet, the node A confirms the highway table 94. The highway table 94 records the information about the node which recognizes the LD because it has performed the forward of a highway data packet and the search of a path. The highway table 94 records the GD affiliated with a cluster other than the local cluster and the LD corresponding to the GD. The node device 10 which is not a sub-gateway may hold no highway table 94.

When the GD of the received highway data packet is not recorded in the highway table 94, the highway data packet process unit 82 of the node A records the highway data packet in the pending data table 83. The pending data table 83 may be in any form capable of recording a highway data packet. The highway data packet process unit 82 notifies the search destination determination unit 71 of the GD of the inner header of the highway data packet, and requests a search of a path.

The search destination determination unit 71 confirms the search log table (SLT) 73. The search log table 73 records the information about the path searched before. Each entry of the search log table 73 includes the data of the LS, the FID, the GS, a done flag, an address list in this order. The column of the LS of the search log table 73 records the address of the node device 10 as the source of a search data packet. The FID records the FID of the data packet included in the highway data packet. The GS records the address of the source node of a highway data packet. The done flag indicates whether or not a search has been completed. In the explanation below, the done flag=0 indicates that the search has not been completed. The done flag=1 indicates that the search has been completed. The address list records the address of the destination node device 10 of a search data packet.

An example of the search log table 73 is indicated by T1. When an entry of the notified GD is not included in the search log table 73, the search destination determination unit 71 records the information about the GD after an entry is generated and notified in the search log table 73. In this case, the LS is the node A, and the GS is the node S. Furthermore, the done flag=0, and the FID is set as FIDO. The search destination determination unit 71 selects a target to be searched from among adjacent clusters, and reports the result to the search execution unit 72. The search execution unit 72 determines the node adjacent to the node A in the sub-gateway of the cluster to be searched as the destination of the search data packet. In this example, it is assumed that the cluster C2 is specified as a target to be searched, and the node B is set as the destination of the search data packet. Furthermore, the search execution unit 72 records the destination (node B) of the search data packet in the address list of the search log table 73.

The search execution unit 72 generates a search data packet. An example of a search data packet generated by the node A is indicated by Pa5. The search data packet generated by the node A has the node A as the GS and the LS. The GD and the LD are the destination node B of the search data packet. The search execution unit 72 sets the value of the SearchType field to 0, the found flag to 0, the hop count to 0, and the value of the KeyGS field as the node S. Furthermore, the search execution unit 72 notifies the node B that the cluster C1 has been searched by specifying the cluster C1 in the Checkedaddr field. The search execution unit 72 of the node A transmits the generated search data packet toward the node B.

The procedure P63 is described below. The search destination determination unit 71 of the node B performs a searching process when it receives a search data packet in which the value of the SearchType field is set to 0. First, the search destination determination unit 71 confirms the value of the Checkedaddr field. In this example, it is recognized from the value of the Checkedaddr field that the local cluster (cluster C2) has not been searched. Then, the search destination determination unit 71 of the node B confirms whether or not the node recorded in the Search ID field of the search data packet has been recorded in the routing table 95. In this example, the routing table 95 of the node B has not recorded the node G. Then, the search destination determination unit 71 recognizes that the node G has not been affiliated with the cluster C2.

Next, the search destination determination unit 71 of the node B extracts the value of the KeyGS field and the KeyFID field of the search data packet, and confirms whether or not an entry associated with the combination of extracted values has been recorded in the search log table 73. In this example, it is assumed that the entry corresponding to the value of the KeyGS field and the value of the KeyFID field is not included in the search log table 73. Then, the search destination determination unit 71 adds the entry to the search log table 73, and sets the values of the LS, the FID, the GS, and the done flag. Next, the search destination determination unit 71 of the node B determines an unsearched cluster as a target to be searched. In this example, the search destination determination unit 71 specifies the cluster C3 as a target to be searched, and notifies the 72 of the specification.

The search execution unit 72 is a sub-gateway of a local cluster, and determines the sub-gateway (node C) adjacent to the sub-gateway included in the cluster C3 as a destination of the search data packet. Therefore, the search log table 73 records the following information.

LS: node A

FID: FIDO

GS: node S

done flag: 0

GD: node C

An example of the search log table 73 is indicated by T2.

Furthermore, the search execution unit 72 transmits the search data packet to the node C. The method of generating a search data packet is similar to the method described above with reference to the procedure P62. An example of a search data packet generated by the node B is indicated by Pa6. The search execution unit 72 of the node B sets the GD of the search data packet as the node C, and the GS and the LS as the node B. Furthermore, the search execution unit 72 sets the hop count to 1, and records in the Checkedaddr field that the cluster C1 and the cluster C2 have been searched. The search execution unit 72 of the node B determines the LS by referring to the routing table 95, and transmits the generated search data packet.

The procedure P64 is described below. The node device 10 in the path from the node B to the node C appropriately changes the LS and the LD each time a search data packet is received, increments the hop count by 1, and forwards the search data packet.

The procedure P65 is described below. Upon receipt of a search data packet which requests a search, the search destination determination unit 71 of the node C recognizes from the value of the Checkedaddr field that the local cluster (cluster C2) has been searched. Then, the search destination determination unit 71 of the node C does not search the routing table 95.

Next, the search destination determination unit 71 of the node C confirms whether or not an entry corresponding to the combination of the value of the KeyGS field of the search data packet and the value of the KeyFID field has been recorded in the search log table 73. In this example, the entry corresponding to the combination of the values obtained from the search data packet is not included in the search log table 73, and therefore the search destination determination unit 71 adds the entry including the following information to the search log table 73.

LS: node B

FID: FIDO

GS: node S

done flag: 0

GD: node D

An example of an added entry is indicated by T3. Since the LS of the search log table 73 is a source node of the search data packet, it is the node B. The search destination determination unit 71 of the node C specifies the cluster C3 as a target to be searched from among adjacent clusters, and notifies the search execution unit 72 of the specification.

The search execution unit 72 transmits a search data packet to the sub-gateway (node D) which is an adjacent node and adjacent to the sub-gateway included in the cluster C3. The method of generating a search data packet is similar to the method described above with reference to the procedure P62. An example of a search data packet generated by the node C is indicated by Pa1. The search execution unit 72 of the node C sets the GD of the search data packet as the node D, and sets the GS and the LS as the node C. In addition, the hop count is a value obtained by adding 1 to the hop count from the node B to the node C. That is, the hop count has the node A as an originating point.

The procedure P66 is described below. Upon receipt of the search data packet which requests a search, the search destination determination unit 71 of the node D confirms the value of the Checkedaddr field. In this example, since the cluster C3 is not included in the Checkedaddr field, the search destination determination unit 71 recognizes that the cluster C3 has not been searched. Then, the search destination determination unit 71 of the node D confirms whether or not the node recorded in the Search ID field is recorded in the routing table 95. In this example, it is assumed that the routing table 95 of the node D has recorded the node G.

Then, the search destination determination unit 71 judges that the search has been completed, and generates a search data packet for notification of a result of the search. The search destination determination unit 71 sets the value of the SearchType field of the search data packet to 1, and the found flag to 1, thereby expressing the reply as notification of the result of the search. Furthermore, the search destination determination unit 71 records the clusters C1 through C3 in the Checkedaddr field. The search destination determination unit 71 records the hop count from the node D to the node G in the hop count field. The search destination determination unit 71 uses the same values in the KeyGS field, the KeyFID field, and the Search ID field as in the search data packet which has requested the search. The search destination determination unit 71 sets the source of the search data packet which has requested the search in the GD. Therefore, the node Cis set as the GD. Furthermore, the GS and the LS are set as the node D. The search destination determination unit 71 transmits the generated search data packet toward the node C.

The procedure P67 is described below. Upon receipt of the search data packet in which the value of the SearchType field is 1, the search destination determination unit 71 of the node C recognizes the notification of the result of the search. Furthermore, the search destination determination unit 71 increments the value of the hop count field by 1.

The 71 records the contents of the search data packet of the SearchType field=1 in the highway table 94. An example of the entry added to the highway table 94 is indicated by T4. The value of the Search ID field is recorded in the GD, the source node of the search data packet is recorded in the LD, and the value of the hop count field of the search data packet after the increment is recorded in the column of Len. That is, the value of Len is the hop count from the node which records the 94 to the GD of the entry. In this example, the hop count is counted from the node C to the node G. If there is an entry having the same GD in the highway table 94, the value having a smaller hop count is used.

the search destination determination unit 71 confirms the search log table 73 and specifies a target to be notified of the information recorded in the payload of the search data packet. In this case, the search destination determination unit 71 searches the columns of the GS and the FID of the search log table 73 using the combination of the values of the KeyGS field and the KeyFID field of the search data packet as keys. In the example in FIG. 39, the columns of the GS and the FID of the search log table 73 are the second and the third columns of the entry of the search log table 73. The done flag of the entry hit in the search log table 73 is changed into 1. Therefore, the entry of the search log table 73 after the change is described as follows.

LS: node B

FID: FIDO

GS: node S

done flag: 1

GD: node D

An example of a change of the entry of the search log table 73 is indicated by T5. The search destination determination unit 71 reports the information notified from the node D to the node specified by the LS of the hit entry. In this case, the search destination determination unit 71 generates the search data packet indicated by Pa9, and transmits the packet toward the node B.

The procedure P68 is described below. Upon receipt of the search data packet in which the value of the SearchType field is 1, the 71 of the node B update the highway table 94 and the search log table 73 by the process similar to the procedure P67 described above. An example of the highway table 94 is indicated by T6. The following data is recorded in the changed entry of the search log table 73.

LS: node A

FID: FIDO

GS: node S

done flag: 1

GD: node C

An example of the search log table 73 after the change is indicated by T7. In addition, the search destination determination unit 71 generates the search data packet indicated by Pa10, and transmit the packet to the node A.

The procedure P69 is described below. Upon receipt of the search data packet, the search destination determination unit 71 of the node A updates the highway table 94 and the search log table 73 by the process similar to the procedure P67 described above. An example of the highway table 94 is indicated by T8. The search log table 73 after the change records the following data.

LS: node A

FID: FIDO

GS: node S

done flag: 1

GD: node B

An example of the search log table 73 is indicated by T9.

The procedure P70 is described below. By the generation of the entry of the node G in the highway table 94, the highway data packet process unit 82 of the node A forwards the highway data packet stored in the pending data table 83 to the node B. In this case, the GD of the outer header of the highway data packet is changed into the node B, and the GS and the LS are changed into the node A.

The procedure P71 is described below. Upon receipt of a highway data packet from the node A, the highway data packet process unit 82 of the node B refers to the routing table 95 using the GD of the inner header of the highway data packet as a key. If no GD is included in the routing table 95, the highway data packet process unit 82 refers to the highway table 94. Since there is an entry of GD=node G generated in the highway table 94, the node B sets the node C registered in the LD of the entry as the GD of the outer header, and forwards the highway data packet to the node C.

In the procedure P72, the process performed when the node C receives a highway data packet from the node B is similar to the procedure P71. The node C changes the address included in the outer header, and forwards the highway data packet to the node D.

The procedure P73 is described below. Upon receipt of a highway data packet from the node C, the highway data packet process unit 82 of the node D searches the routing table 95 using the GD of the inner header of the highway data packet as a key. Since the GD is recorded in the routing table 95, the highway data packet process unit 82 removes the outer header of the highway data packet, and outputs it to the data packet process unit 81. An example of the data packet output to the data packet process unit 81 is indicated by Pall. The data packet process unit 81 refers to the routing table 95, and forwards the data packet to the node G.

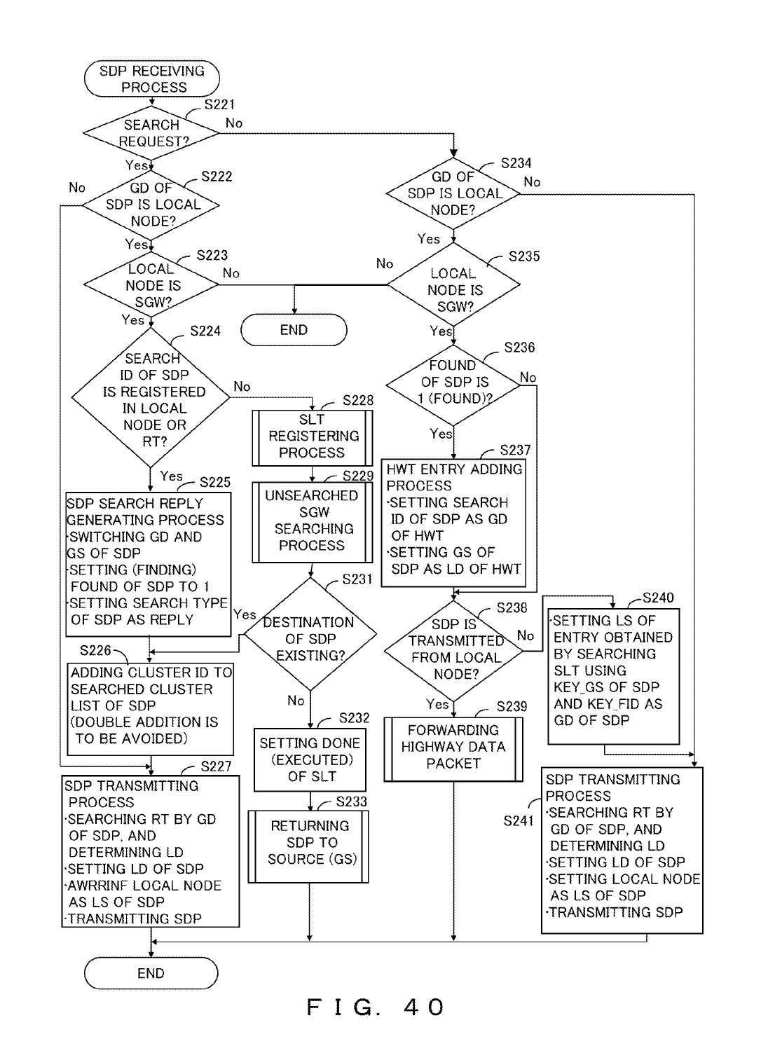

FIG. 40 is a flowchart for explanation of an example of a process of a search data packet (SDP). FIG. 40 illustrates the operation of the node which has received a search data packet. In the explanation in FIG. 40, the node which has received a search data packet may be described as a “local node”.

Upon receipt of a search data packet, the search destination determination unit 71 judges whether or not a search is request based on the SearchType field (step S221). When a search is requested, the search destination determination unit 71 confirms whether or not the local node matches the GD of the search data packet (step S222 after YES in step S221). If the local node is not the GD of the search data packet, a process is performed to forward the search data packet to a destination (step S227 after NO in step S222). When the local node is the GD of the search data packet, the search destination determination unit 71 further confirms whether or not the local node is a sub-gateway (step S223 after YES in step S222). If the local node is not a sub-gateway, the search destination determination unit 71 terminates the process (NO in step S223). When the local node is a sub-gateway, it is judged whether the node recorded in the Search ID field is the local node or the node recorded in the routing table 95 (step S224). If the node recorded in the Search ID field is the local node or the node recorded in the routing table 95, the search terminates (YES in step S224). Then, the search destination determination unit 71 generates a search data packet for notification of a result of the search (step S225). In this case, the search destination determination unit 71 switches the GS and the GS, and sets the found flag to 1. The search destination determination unit 71 changes the value of the Type field to 1. The search destination determination unit 71 also changes the value of the Type field to 1. Next, the search destination determination unit 71 records the cluster ID for identification of the local cluster of the local node in the searched cluster list (step S226). Then, the search destination determination unit 71 transmits the generated search data packet (step S227). In this case, the search destination determination unit 71 searches the routing table 95 of the GD in the search data packet, and sets the obtained LD as the LD of the search data packet. Furthermore, the local node is set as the LS of the search data packet.

If the node recorded in the Search ID field is not a local node, or the node recorded in the routing table 95 in step S224, then the search destination determination unit 71 performs a registering process on the search log table 73 (step S228). Furthermore, the search destination determination unit 71 specifies the cluster to be searched in which a search has not been performed in the adjacent clusters, and selects a sub-gateway affiliated with the cluster to be searched (step S229). When the destination of the search data packet is obtained, the search destination determination unit 71 records the destination node in the search log table 73, and performs the processes in and after step S226 (YES in step S231). On the other hand, if the destination of the search data packet is not obtained because, for example, a search of all adjacent clusters has not been performed, then the search execution unit 72 sets the done flag of the search log table 73 to 1 (NO in step S231, and step S232). Furthermore, the search execution unit 72 returns the search data packet for notification that the search has been completed to the source of the search data packet (step S233). Since the SearchType field=1 is set in the search data packet transmitted in step S233, the destination node recognizes the reply to the search data packet. In this example, since the path to the node to be searched has not been found, the found flag in the search data packet is set to 0.

When the received search data packet reports a result of a search, the search destination determination unit 71 confirms whether or not the local node matches the GD of the search data packet (step S234 after NO in step S221). If the local node is not the GD of the search data packet, the process for forwarding the search data packet to the destination is performed (step S241 after NO in step S234). In the local node is the GD of the search data packet, the search destination determination unit 71 further confirms whether or not the local node is a sub-gateway (step S235). If the local node is not a sub-gateway, the search destination determination unit 71 terminates the process (NO in step S235). If the local node is a sub-gateway, it is confirmed whether or not the found flag of the search data packet is 1 (step S236). If the found flag is 1, the search destination determination unit 71 records the contents notified by the search data packet in the highway table 94 (step S237 after YES in step S236). In this case, the node recorded in the Search ID field of the search data packet is recorded as the GD of the highway table 94. In addition, the GS of the search data packet is recorded as the LD of the highway table 94. Furthermore, the search destination determination unit 71 sets the hop count of the highway table 94. On the other hand, when the found flag is not 1, the search destination determination unit 71 performs the process in step S238 without performing the process in step S237 (NO in step S236). When the local node starts an inquiry using a search data packet, the node device 10 transmits a highway data packet using the highway table 94 (step S239 after YES in step S238). It is judged whether or not the local node has started an inquiry using a search data packet by searching the search log table 73 by a combination of the values of the KeyGS field and the KeyFID field of the search data packet. If the LS of the entry which matches the combination of the values of the KeyGS field and the KeyFID field of the search data packet is the local node, it is judged that the local node has started an inquiry. On the other hand, if the local node is not the node which has started the inquiry using a search data packet, then the search execution unit 72 acquires the LS of the entry which matches the combination of the values of the KeyGS field and the KeyFID field from the search log table 73 (step S240). The search execution unit 72 sets the LS obtained from the search log table 73 as the GD of the search data packet. Afterwards, the search destination determination unit 71 transmits the generated search data packet (step S241). The method of generating the search data packet transmitted in step S241 is similar to that in step S227.

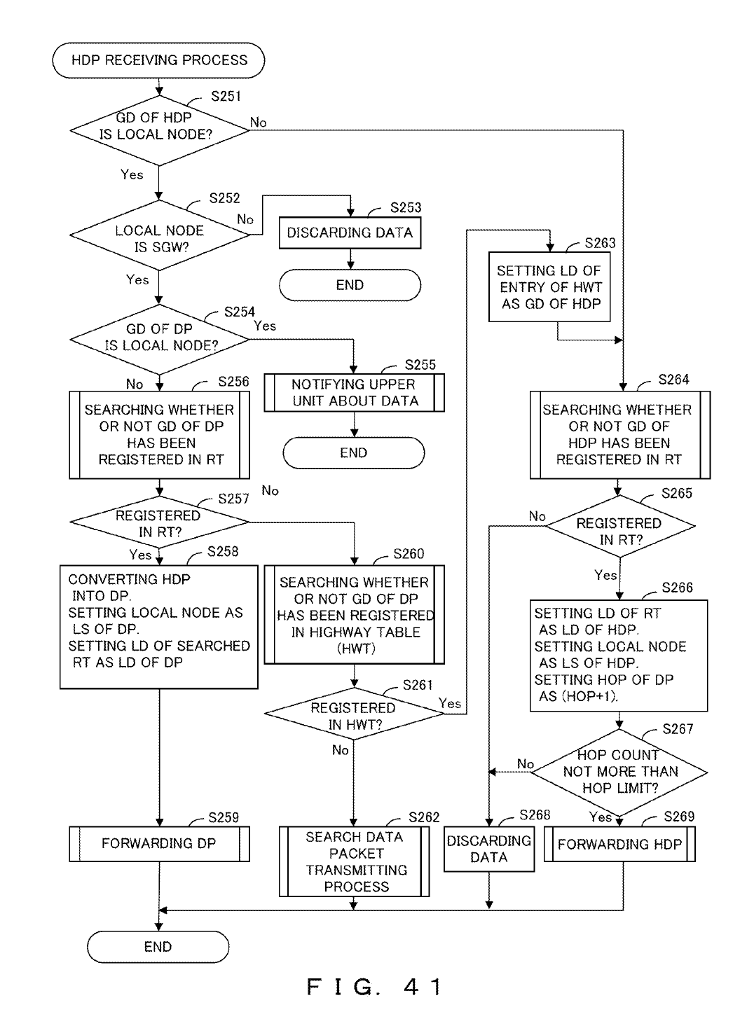

FIG. 41 is a flowchart for explanation of an example of a process of a highway data packet. FIG. 41 illustrates the operation of the node which has received the highway data packet, and the explanation in FIG. 41 may describe the node which has received the highway data packet as a “local node”.

The highway data packet process unit 82 judges whether or not the GD of the received highway data packet is the local node (step S251). If the GD of the highway data packet is the local node, the highway data packet process unit 82 confirms whether or not the local node is a sub-gateway (step S252 after YES in step S251). If the local node is not a sub-gateway, then the highway data packet process unit 82 discards data and terminates the process (step S253 after NO in step S252).

On the other hand, if the local node is a sub-gateway, then the highway data packet process unit 82 confirms whether or not the GD (GD of the data packet) of the inner header is the local node (step S254 after YES in step S252). If the GD is the local node, the highway data packet process unit 82 outputs data to the upper process unit 14 and terminates the process (step S255 after YES in step S254). If the GD is not the local node, it is confirmed whether or not the GD of the inner header has been registered in the routing table 95 (step S256 after NO in step S254). If the GD has been registered in the routing table 95, it indicates that the GD is located in the local cluster (YES in step S257). Then, the highway data packet process unit 82 converts the highway data packet into a data packet, and outputs the resultant packet to the data packet process unit 81. Furthermore, the data packet process unit 81 defines the LS of the data packet as the local node, and the LD of the data packet as an LD recorded in the routing table 95 as associated with the GD (step S258). The data packet process unit 81 forwards the data packet (step S259).

In step S257, if it is judged that the GD has not been registered in the routing table 95, the highway data packet process unit 82 confirms whether or not the GD of the inner header has been registered in the highway table 94 (step S260 after NO in step S257). If the GD has not been registered in the highway table 94, the search data packet is transmitted (step S262 after NO in step S261). On the other hand, when the GD is registered in the highway table 94, the LD of the highway table 94 is set as the GD (GD of the outer header) of the highway data packet (step S263 after YES in step S261). Afterwards, the highway data packet process unit 82 confirms whether or not the GD of the outer header of the highway data packet has been registered in the routing table 95 (steps S264 and S265). If the GD of the outer header has not been registered in the routing table 95, the highway data packet process unit 82 discards the data and terminates the process (step S268 after NO in step S265).

On the other hand, if the GD has been registered in the routing table 95, the LD recorded in the corresponding entry in the routing table 95 is set as the LD of the outer header. In addition, the LS of the outer header is set as the local node, and the hop count of the data packet is incremented by 1 (step S266 after YES in step S265). When the value of the hop count is not more than the hop limit stored in advance, the highway data packet process unit 82 forwards a highway data packet (step S269). On the other hand, if the value of the hop count exceeds the hop limit stored in advance, the highway data packet process unit 82 discards the data (step S268 after NO in step S267). Furthermore, if it is judged in step S251 that the GD of the highway data packet is not the local node, the processes in and after step S264 are performed.

The operation performed when a highway data packet is generated is explained below with reference to FIG. 35. When the GD of the data packet is affiliated with a cluster different from the local cluster, it is judged NO in step S194, and the generation of a highway data packet is started (step S198). In the following explanation, the operation of a node which generates a highway data packet is explained below with reference to steps S198 through S210. Furthermore, in the explanation in steps S198 through S210, the node which generates a highway data packet is described as a “local node”.

The highway data packet process unit 82 confirms whether or not the local node is a sub-gateway (step S199). If the local node is not a sub-gateway, the highway data packet process unit 82 acquires the path to the default gateway from the routing table 95 (steps S200 and S201). The highway data packet process unit 82 sets the address of a highway data packet etc. (step S202). That is, the highway data packet process unit 82 sets the default gateway as the GD of the highway data packet, and the local node as the GS of the highway data packet. Furthermore, the highway data packet process unit 82 sets the LD of the highway data packet as the LD of the path to the default gateway, and increments the hop count of the data packet by 1. If the hop count is not more than the hop limit, the highway data packet process unit 82 forwards the highway data packet (step S209 after YES in step S208). On the other hand, if the hop count exceeds the hop limit, the highway data packet process unit 82 discards the highway data packet (NO in step S208).

If it is judged in step S199 that the local node is a sub-gateway, it is confirmed whether or not the GD (GD of the data packet) of the inner header has been registered in the highway table 94 (steps S203 and S204). If the GD of the inner header has been recorded in the highway table 94, the highway data packet process unit 82 sets the node registered as the LD of the path to the GD in the highway table 94 as the GD of the outer header. Furthermore, the highway data packet process unit 82 sets the GS of the highway data packet as the local node (step S205). Next, the highway data packet process unit 82 acquires an entry which matches the GD of the outer header of the highway data packet from the routing table 95 (step S206). The highway data packet process unit 82 specifies the node recorded as the LD in the acquired entry as the LD of the outer header, and specifies the LS as the local node. Furthermore, the highway data packet process unit 82 increments the hop count of the data packet by 1 (step S207). When the hop count is not more than the hop limit, the highway data packet process unit 82 forwards the highway data packet. If the hop count exceeds the hop limit, it discards the highway data packet (steps S208 and S209). If it is judged in step S204 that it has not been registered in the highway table 94, the sub-gateway performs the process of transmitting a search data packet (step S210).

As explained above, according to the node device of the present embodiment, the capacity of the routing tables is suppressed.

<Others>

In the example described above, the generation of a new cluster is started when the number of nodes in the cluster reaches the threshold. However, the timing of the generation of a new cluster depends on the implementation. For example, the generation of a new cluster may be started when the number of nodes in a cluster reaches 80% of the threshold.

The format of the packet illustrated in the explanation above is an example only. The format of a packet may be appropriately changed depending on the implementation.

Furthermore, in the explanation above, the number of the originating node devices which generate a cluster is one, but there may be a plurality of originating node devices which generate a cluster. Also in this case, the operation of each originating node device is described above.

Additionally, the cluster ID may be defined as the address of the originating node device of a cluster. In this case, since the cluster ID and the address of the originating node device match, the cluster table 92 may store one of the cluster ID and the address of the originating node device, thereby saving the memory area.

All examples and conditional language provided herein are intended for pedagogical purposes of aiding the reader in understanding the invention and the concepts contributed by the inventor to further the art, and are to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A node device, comprising:
a receiver configured to receive a path information packet for notification of path information about a network;
a processor configured to generate a participation request packet for requesting a first node device selected between an adjacent node device and a node device communicable through the adjacent node device to participate in a first local cluster;
a memory configured to store a path to each affiliated node device affiliated with the first cluster; and
a transmitter configured to transmit the participation request packet to the first node device, wherein:
when a number of affiliated node devices which are affiliated with the first cluster exceeds a threshold, the processor generates a generation request packet for requesting a second node device which is not affiliated with the first cluster to generate a second cluster different from the first cluster; and
the transmitter transmits the generation request packet to the second node device.

2. The device according to claim 1, wherein
the processor
specifies an unaffiliated node device not affiliated with any cluster between the adjacent node device and a node device communicable through the adjacent node device;
records the unaffiliated node device in an unaffiliation table;
selects a node device which requests for participation on the first cluster from among node devices recorded in the unaffiliation table; and
deletes the affiliated node device from the unaffiliation table,
specifies a node device not affiliated with any cluster in node devices adjacent to the affiliated node device according to information reported from the affiliated node device, and
records the node in the unaffiliation table.

3. The device according to claim 1, wherein
the processor
upon receipt of an adjacent cluster notification for notification that anode device adjacent to the affiliated node device is affiliated with the second cluster from the affiliated node device, associates a source of the adjacent cluster notification with the second cluster, and records the source and the second cluster in a candidate table; and
determines the node device selected from the candidate table as a sub-gateway which is a node device operating as a gateway between the second cluster and the first cluster.

4. The device according to claim 3, wherein
the processor requests the sub-gateway to store a path to a node device not to be affiliated with the first cluster and adjacent to the sub-gateway in a routing table, and to allow a node device included in a cluster reported in the adjacent cluster notification to operate as another sub-gateway.

5. The device according to claim 3, wherein
when a plurality of sub-gateways are included in a local cluster, the processor determines a sub-gateway having a communication condition higher than a specified condition as a default gateway to be selected on a priority basis as a relay destination for a data packet addressed to a node device which is not included in the local cluster.

6. A communication method, comprising:
requesting, by a first node device, an adjacent node device to the first node device and a node device communicable through the adjacent node device to participate in a first cluster, thereby generating a first cluster including the first node device;
communicating, by an affiliated node device which is affiliated with the first cluster, a path information packet for notification of path information, thereby storing a path to another affiliated node device in a routing table; and
repeating, by the first node device, requesting to participate in the first cluster and store a path in the routing table until a number of the affiliated node devices exceeds a threshold and
when the number of affiliated nodes exceeds the threshold, requesting a second node device which is not affiliated with the first cluster to generate a second cluster different from the first cluster.

7. The method according to claim 6, further comprising:
determining, by the first node device, a node device which is affiliated with the first cluster and adjacent to a third node device as a first sub-gateway which is a node device operating as a gateway between the first cluster and the second cluster, the third node being affiliated with the second cluster;
setting, by the first sub-gateway, the third node device as a second sub-gateway operating as a gateway between the first cluster and the second cluster; and
storing, by the first sub-gateway, a path to the second sub-gateway in the routing table.

8. The method according to claim 6, further comprising:
storing, by the first sub-gateway, a data packet including data to be transmitted from the affiliated node device to a fourth node device affiliated with a cluster which is different from the first cluster;
issuing, by the first sub-gateway, an inquiry to the second sub-gateway about a path to the fourth node device;
when the fourth node device is recorded in a routing table stored in the second sub-gateway, notifying, by the second sub-gateway, the first sub-gateway of a path to the fourth node device; and
transmitting, by the first sub-gateway, the data packet to the fourth node device using the notified path.

9. The method according to claim 8, further comprising:
when the fourth node device is not recorded in a routing table stored by the second sub-gateway, issuing, by the second sub-gateway, an inquiry to a third sub-gateway affiliated with the second cluster about a path to the fourth node device;
issuing, by the third sub-gateway, an inquiry about a path to the fourth node device to a fourth sub-gateway which is adjacent to the third sub-gateway and is not affiliated with the second cluster;
when the fourth node device is recorded in a routing table stored by the fourth sub-gateway, notifying, by the fourth sub-gateway, the third sub-gateway of a path to the fourth node device; and
notifying, by the third sub-gateway, the second sub-gateway of a path to the fourth node device.

10. A non-transitory computer-readable recording medium having stored therein a program for causing a computer to execute a process comprising:
receiving a path information packet for notification of path information about a network;
transmitting a control packet for requesting an adjacent node device and a node device which is communicable through the adjacent node device to participate in a first cluster;
storing in a routing table a path to an affiliated node device which is affiliated with the first cluster; and
when a number of the affiliated node devices exceeds a threshold, transmitting a control packet for requesting to generate a second cluster other than the first cluster to a node device not affiliated with the first cluster.
